(19) United States
(12) Patent Application Publication
(10) Pub. No.: US 2026/0291840 A1
(43) Pub. Date: Sep. 24, 2026

(54) Method and System for Monitoring and Analyzing Electric Power Consumption by Electrical Appliances Using WiFi Access Point as a Central Hub

(71) Applicant: T-Mobile Innovations LLC, Overland Park, KS (US)

(72) Inventor: Do Kyu LEE, Mercer Island, WA (US)

(21) Appl. No.: 19/088,596

(22) Filed: Mar. 24, 2025

(51) Int. Cl. H04L 43/0817; G16Y 10/80; G16Y 20/30; G16Y 40/40

(52) U.S. Cl. CPC H04L 43/0817; G16Y 10/80; G16Y 20/30; G16Y 40/40

(57) ABSTRACT

A computer-implemented method of collecting, monitoring, and analyzing power consumption information associated with individual electrical appliances, the method includes establishing wireless communication links with smart plugs, each electrically coupled between an electrical power outlet and one or more of electrical appliances and comprises sensors for sensing a current and/or a voltage; receiving a mapping between the electrical appliances and the smart plugs; receiving, from individual ones of the smart plugs, sensing data comprising current and/or voltage consumption information; associating based on the mapping, at least one electrical appliance of the electrical appliances with respective sensing data; calculating power consumption information for the at least one electrical appliance based on the respective sensing data; detecting an anomaly based on the sensing data and/or the power consumption information associated with the at least one electrical appliance fails to satisfy one or more criteria; and initiating an action to resolve the detected anomaly.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

There are various electrical appliances that an individual or a household may use on a daily basis. Examples of these electrical appliances may include, but are not limited to, refrigerators, washing machines, dryers, dishwashers, ovens, microwaves, televisions, air conditioners, heaters, fans, toasters, toaster ovens, coffee makers, blenders, lights, hairdryers, computers, and laptops. Electrical appliances require electric power to operate. For instance, each facility (e.g., a house) may have an electric main that supplies electricity to the facility. The electric main may be located outside of a facility. A utility company serving the facility may install an electric meter near the electric main of the facility to track the amount of electric power consumed by the facility (or more specifically, by the electrical appliances at the facility). The utility company may read the electric meter periodically and calculate billing information based on the amount of power consumed by the facility and a rate plan subscribed by the owner of the facility.

### SUMMARY

In an embodiment, a computer-implemented method of collecting, monitoring, and analyzing power consumption information associated with individual electrical appliances is disclosed. The method includes establishing, by an application stored in a non-transitory memory of a communication hub device and executable by a processor of the communication hub device, wireless communication links with respective ones of a plurality of smart plugs, each electrically coupled between an electrical power outlet and one or more of a plurality of electrical appliances and comprises one or more sensors for sensing at least one of a current or a voltage; receiving, by the application, a mapping between each of the plurality of electrical appliances and a respective one of the plurality of smart plugs, the mapping being based on a respective electrical coupling; receiving, by the application, from individual ones of the plurality of smart plugs, sensing data comprising at least one of current or voltage consumption information; associating, by the application, based on the mapping, at least one electrical appliance of the plurality of electrical appliances with respective sensing data; calculating, by the application, a power consumption of the at least one electrical appliance based on the respective sensing data; detecting, by the application, an anomaly based on at least one of the sensing data or the power consumption associated with the at least one electrical appliance fails to satisfy one or more criteria; and initiating, by the application, an action to resolve the detected anomaly.

In another embodiment, a computer-implemented method of collecting, monitoring, and analyzing power consumption information associated with individual electrical appliances is disclosed. The method includes establishing, by an application stored in a non-transitory memory of a communication hub device and executable by a processor of the communication hub device, wireless communication links with respective ones of a plurality of electrical metering-capable devices, each electrically coupled to one or more of a plurality of electrical appliances and comprising one or more sensors for sensing at least one of a current or a voltage, wherein the plurality electrical metering-capable devices comprise at least one of a smart circuit breaker or a smart plug; displaying, by the application, via a first user interface (UI), an indication of the plurality of electrical metering-capable devices based on the established wireless communication links; receiving, by the application, via the UI, a mapping between the plurality of electrical appliances and the plurality of electrical metering-capable devices; receiving, by the application, from the one or more sensors at individual ones of the plurality of electrical metering-capable devices, sensing data comprising at least one of current or voltage consumption information; associating, by the application, based on the mapping, individual ones of the plurality of electrical appliances with respective sensing data; calculating, by the application, a power consumption for the individual ones of the plurality of electrical appliances based on the respective sensing data; and outputting, by the application, to a second UI, an indication of the calculated power consumption for the individual ones of the plurality of electrical appliances.

In yet another embodiment, a method includes establishing, by an application stored in a non-transitory memory of a communication hub device and executable by a processor of the communication hub device, wireless communication links with respective ones of a plurality of smart circuit breakers associated with a home, wherein each of the plurality of smart circuit breakers electrically couples an electric main of the home to one or more of a plurality of electrical appliances associated with the home and comprises one or more sensors for sensing at least one of a current or a voltage; receiving, by the application, a mapping between each of the plurality of electrical appliances and a corresponding one of the plurality of smart circuit breakers, the mapping being based on a respective electric coupling; receiving, by the application, from individual ones of the plurality of smart circuit breakers, sensing data comprising at least one of current or voltage consumption information; associating, by the application, based on the mapping, at least one electrical appliance of the plurality of electrical appliances with respective sensing data; calculating, by the application, power consumption information for the at least one electrical appliance based on the respective sensing data; detecting, by the application, an anomaly based on a comparison of the power consumption information of the at least one electrical appliance to reference power consumption data; and transmitting, by the application to a user device, a notification of the detected anomaly.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, where like reference numerals represent like parts.

FIG. 1 is a block diagram of a home environment that provides monitoring and analysis of power consumption by individual electrical appliances according to an embodiment of the disclosure.

FIG. 2 is a block diagram of another home environment that provides monitoring and analysis of power consumption by individual electrical appliances according to an embodiment of the disclosure.

FIG. 3 is a sequence diagram illustrating a method of collecting, monitoring, and analyzing power consumption by individual electrical appliances according to an embodiment of the disclosure.

FIG. 4 illustrates an example user interface (UI) according to an embodiment of the disclosure.

FIG. 5 illustrates another example UI according to an embodiment of the disclosure.

FIG. 6 illustrates yet another example UI according to an embodiment of the disclosure.

FIG. 7 is a flow chart of a method according to an embodiment of the disclosure.

FIG. 8 is a flow chart of another method according to an embodiment of the disclosure.

FIG. 9A and FIG. 9B are block diagrams of a fifth generation (5G) network according to an embodiment of the disclosure.

FIG. 10 is a block diagram of a computer system according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

A utility company that provides electricity for a facility (e.g., a house) may provide a billing statement detailing the cost and the amount of electric power used by the facility for each billing cycle (e.g., each month). The billing statement may indicate the total amount of electric power usage (e.g., in terms of kilowatt-hours (kWh)) over the billing cycle but may not provide a breakdown of power usage (e.g., in kWh) by electrical appliances at the facility or by sections or bays (e.g., bedroom 1, bedroom 2, kitchen, laundry, living room, etc.) of the facility over the billing cycle. This is because a utility company may commonly install a single meter at an electric main of a facility to measure the total amount of electric power used by the facility and may typically have no knowledge of the electrical wirings at the facility, let alone the electrical appliances used by the facility. In some situations, it may be desirable for users to have knowledge of electric power usage at a more granular level, for example, by electrical appliances and/or by sections of the facility so that the users may be able to more effectively reduce their electrical usage and/or cost and/or monitor for faulty conditions. For instance, one benefit of providing electric power usage at a more granular level is that the user can anticipate their next bill and possibly change power consumption before being hit with a high bill at the end of the billing cycle.

While there are smart electrical appliances (e.g., refrigerators, ovens, washing machines, dryers, etc.) equipped with wireless communication capabilities available, the wireless communication is mostly used for carrying instructions to control the power state of the smart electrical appliances (e.g., power on or off). For instance, a smart electrical appliance may communicate with a mobile device (e.g., a laptop, a tablet, or user equipment (UE)) where a user may turn the smart electrical appliances on or off remotely (e.g., via an application executing on the mobile device). Replacing traditional electrical appliances (that are without wireless communication capabilities) with smart electrical appliances can be costly and may take time. One interim solution is to utilize smart plugs equipped with capabilities for wireless communications and power state controls (e.g., for powering on, powering off, or controlling the flow of electric power at certain increments). To that end, a smart plug may be plugged into an electrical outlet and a traditional electrical appliance may be plugged into the smart plug. In this way, the smart plug may communicate with a mobile device, and a user may control the power state of the smart plug remotely (e.g., via an application executing on the mobile device), thereby controlling the power state of the traditional electrical appliance. While smart plugs may provide remote power state controlling capabilities and/or the amount of time that the traditional electrical appliance is powered on (or powered off), these smart plugs may typically not provide any current consumption information.

The present disclosure provides a technical solution to the aforementioned technical problems in the technical field of electrical appliance power consumption detection and analysis using a communication hub device (e.g., in a home environment). More specifically, the communication hub device may collect information on consumption of electric power and/or electric current by home appliances (or generally, electrical appliances) and present useful information about that electric power consumption to a user. In one example, the electric power and/or electric current consumption information may be determined by a smart plug disposed between an electric outlet (or power outlet) and a given home appliance, and the smart plug may transmit that electric power and/or electric current consumption information to the communication hub device. Alternatively, a smart circuit breaker in an electric power distribution panel in the home (e.g., in the garage) may fulfil the same function.

To facilitate providing electric power consumption information per individual home appliance and/or per section (or per bay) of a home, the electric power consumption information needs to be associated with a respective home appliance and a meaningful name. This may involve a user configuring the communication hub device with this naming information (e.g., a mapping between home appliances and smart plugs or smart circuit breakers). Alternatively, the communication hub device may infer what home appliances may be associated with which smart circuit breaker or which smart plug based on electric power consumption pattern analysis. For example, a distinctive pattern of consuming electric power may be attributable to specific appliances—a refrigerator, an air-conditioner compressor, a blower, an electric dryer, etc. In some instances, this pattern analysis may be based on machine learning (ML) processing.

The communication hub device may analyze the electric power and/or electric current consumption information received from the smart plugs and/or the smart circuit breakers to detect for special conditions and notify a user (e.g., by sending a notification to a user's mobile device or phone) of the detected special conditions. Examples of special conditions may include, but are not limited to, a potential current overload, a ground-fault circuit interrupter (GFCI) circuit trip, a power consumption that deviates from a norm (e.g., based on statistics of other consumers), and a potential increase in billing for an upcoming billing cycle (e.g., based on past billing data).

According to an embodiment of the present disclosure, a home environment may include a communication hub device (e.g., a computer system, a network router), smart plugs, and electrical appliances (e.g., electrical home appliances) electrically coupled to electric power outlets via respective smart plugs. Each of the smart plugs may include one or more sensors that sense a current and/or a voltage delivered to respective electrical appliances via the smart plug. Each of the smart plugs may further include a wireless communication device to communicate sensing data (e.g., current and/or voltage consumption information) sensed by the one or more sensors to the communication hub device. To that end, the communication hub device may execute a power consumption application, and the power consumption application may establish wireless communication links (e.g., wireless network connections), each with a respective one of the smart plugs. The establishing of the wireless communication links may include device discovery (e.g., network discovery by the smart plugs), authentication (e.g., checking security and compatibility), and association between the communication hub device and the smart plugs. In certain examples, the wireless communication links may be WiFi connections (e.g., as defined by the Institute of electrical and electronics engineers (IEEE) 802.11).

The power consumption application may receive a mapping between each of the home appliances and a corresponding one of the smart plugs based on a respective electric coupling. Stated differently, the mapping may indicate which electrical appliance is connected to which smart plug. In one embodiment, the power consumption application may display, via a user interface (UI), an indication of the smart plugs (e.g., detected devices) based on the established wireless communication links, and a user may configure the mapping via the UI. In one example, the UI may be part of a web portal associated with the communication hub device (e.g., for administrative control of the communication hub device), and the user may log into the web portal via a browser (e.g., during setup of the smart plugs) to configure the mapping. In another example, the UI may be part of a web application executing on a user's mobile device (e.g., mobile phone, tablet, etc.), and the user may configure the mapping from the web application. In some instances, the configuration of the mapping can be part of a wireless communication link establishment (e.g., during an authentication process). In other instances, the configuration of the mapping can occur after the wireless communication links are established.

In some embodiments, the mapping may indicate an electrical appliance name identifier for each electrical appliance and an association with a corresponding one of the smart plugs. As an example, the mapping may indicate that an oven is connected to a smart plug A, a fridge is connected to a smart plug B, and so on. Generally, the user may assign any suitable names to the electrical appliances (e.g., using anonymized names for privacy). In some instances, the power consumption application may further receive information indicating whether an electrical appliance is opted-in or opted-out for power consumption collection and analysis. That is, the UI may provide a user with the option to opt-in or opt-out a particular electrical appliance for power consumption collection and analysis.

In some embodiments, the power consumption application may assist or ease the user in configuring the mapping. For instance, the power consumption application may further display a list of candidate electrical appliances for each smart plug along with the listing of the smart plugs. As an example, the UI may display a smart plug A with two candidate electrical appliances (e.g., an oven and a fridge) and a smart plug B with three candidate electrical appliances (e.g., a lamp, a laptop, and a speaker). As such, the user may select and confirm the electrical appliance(s) that are connected to the corresponding smart plug. The power consumption application may determine the list of candidate electrical appliances based on an analysis of current and/or voltage consumption sensed by the respective smart plugs. As discussed above, different types of electrical appliances may have different, distinctive current and/or voltage consumption patterns. In some instances, the power consumption application may apply an ML model to the current and/or voltage consumption sensed by the respective smart plugs to determine the list of candidate electrical appliances for each smart plug.

Next, the power consumption application may receive, from the one or more sensors at individual ones of the smart plugs, sensing data comprising at least one of current or voltage consumption information. The power consumption application may associate each of the electrical appliance with respective sensing data based on the mapping. The power consumption application may calculate power consumption information for each of the electrical appliances based on respective sensing data (e.g., by multiplying a respective current measurement with a corresponding voltage measurement). In some instances, the power consumption application may receive the sensing data from each of the smart plug periodically (e.g., per minute, per 10 minutes, per 30 minutes, per hour, or per any suitable time period), and may calculate per hour power consumption information (e.g., in units of kWh).

The power consumption application may display the calculated power consumption information for each of the electrical appliances via a UI (e.g., a dashboard in the web portal or the web application discussed above). For instance, the user may open the web application on the user's mobile device or the web portal and request for the power consumption information. In an example, the calculated power consumption information may be displayed for each electrical appliance along with a corresponding electrical appliance name as configured by the user during the setup (e.g., 2 kWh for the refrigerator, 1 kWh for the oven, 1 kWh for washing machine, etc.). Generally, for each electrical appliance, the power consumption application can display a current power consumption (e.g., in real-time), a total power consumption for the day, a daily average power consumption, a total power consumption for the month, a monthly average power consumption, and/or any suitable power consumption statistics (e.g., a maximum power consumption, a minimum power consumption, a deviation from a certain reference, etc.).

In some embodiments, the power consumption application may analyze the sensing data received from the one or more sensors at individual ones of the smart plugs to monitor for an anomaly (or a special condition) associated with one or more of the electrical appliances. For instance, as part of analyzing the sensing data, the power consumption application may detect an anomaly associated with a first electrical appliance of the electrical appliances based on a comparison of the power consumption information for the first electrical appliance with reference power consumption data. Upon detecting the anomaly, the power consumption application may transmit a notification to notify the user of the detected anomaly. For instance, if the web application on the user's mobile device is configured to allow an alert (e.g., an audio or a visual alert) associated with power consumption to be sent to the mobile device, the power consumption application may send an alert to the web application to indicate the detected anomaly. In some instances, the power consumption application may additionally request the user to modify a power configuration or setting for the first electrical appliance based on an amount of power consumption deviation from the reference power consumption data exceeding a certain threshold.

The reference power consumption data used for the comparison can be from a variety of sources. In one embodiment, the reference power consumption data (used for the comparison) may include past power consumption data (e.g., minimum, maximum, or average power consumption) associated with the particular first electrical appliance in the home environment. For instance, the power consumption application may store calculated power consumption information for each electrical appliance in a database (e.g., an individual home database for the specific home environment) and may compare newly calculated power consumption information for specific ones of the electrical appliances with previous calculated power consumption information (for the specific ones of the electrical appliances) stored in the individual home database. For instance, the power consumption application may compare current daily average power consumption of the first electrical appliance with past daily average power consumption of the first electrical appliance in the last 30 days. In another embodiment, the reference power consumption data (used for the comparison) may include other power consumption data (e.g., minimum, maximum, or average power consumption) associated with electrical appliances of the same product type as the first electrical appliance. In such an embodiment, the power consumption data may be general power consumption information for that product type or power consumption information obtained from neighboring homes having the same type of electrical appliances.

In some embodiments, the power consumption application may predict an electrical billing cost for the home in a current billing cycle based on the sensing data received from the one or more sensors at the individual ones of the smart plugs. The power consumption application may further detect an anomaly based on a comparison of the predicted electrical billing cost and at least one of past electrical billing information associated with the home or electrical billing information associated with neighboring homes. For instance, the power consumption application may have information about the rate plan subscribed by the homeowner and thus may predict the amount of power consumed by the home for a current billing cycle based on usage patterns of the electrical appliances and predict the billing cost based on the rate plan and the predicted power usage. If the power consumption application determines that the predicted billing cost is higher than expected (e.g., an average of past billing and/or other neighboring homes), the power consumption application may determine that an anomaly is detected. The power consumption application may thus send an alert to notify the user (e.g., via the web application on the user's mobile device) prior to the end of the current billing cycle.

In some embodiments, the power consumption application may detect an anomaly based on at least one of the sensing data or the power consumption information associated with a first electrical appliance of the plurality electrical appliances failing to satisfy one or more criteria. Upon detecting the anomaly, the power consumption application may initiate an action to resolve the detected anomaly. In an example, detecting the anomaly may include determining that a current load associated with an electrical power outlet coupled to the first electrical appliance via a first smart plug of the smart plugs fails to satisfy a threshold. Accordingly, initiating the action to resolve the detected anomaly condition may include instructing the first smart plug to be switched off or modify the power state of the first electrical appliance (e.g., by transmitting an instruction to the first smart plug to set the first smart plug to a power off state or modify the power state of the first electrical appliance). Modifying the power state of the first electrical appliance may include cutting off the power supply to the first electrical appliance or reducing or restricting the amount of current flow or power to the first electrical appliance. In another example, an electrical outlet that is electrically coupled to a second electrical appliance of the electrical appliance via a second smart plug of the smart plugs includes a GFCI circuit, and detecting the anomaly may include detecting that the GFCI circuit is tripped. Accordingly, initiating the action to resolve the detected anomaly condition may include transmitting a notification to the user (e.g., via the web application on the user's mobile device) to reset the GFCI circuit.

Generally, upon the application detecting an imminent current overload or GFCI tripping and at least one of the electrical appliances attached to that circuit or smart plug is more critical to preserve (e.g., in an order of freezer, microwave, blender, mixer, etc.), then the application may determine to cut off the power or at least restrict the power to one of the other electrical appliances coupled to the same circuit or same smart plug which is less critical (e.g., a blender or mixer) to protect the freezer. For instance, initiating the action to resolve the detected anomaly condition, the application may prioritize another one of the electrical appliances (coupled to the same first smart plug) over the first electrical appliance and instruct the first smart plug to cut off or restrict the power to the first electrical appliance. Prioritizing the other electrical appliance over the first electrical appliance may be based on a predetermined order of criticality for the electrical appliances.

According to another embodiment of the present disclosure, smart circuit breakers may be used in place of the smart plugs. For instance, a home environment may include a communication hub device, electrical appliances, and smart circuit breakers (e.g., on a power distribution panel of the home) that couple an electric main of the home to the electrical appliances. Each of the smart circuit breakers may include one or more sensors that sense a current and/or a voltage delivered to respective electrical appliances via the smart circuit breaker. Each of the smart circuit breakers may further include a wireless communication device to communicate sensing data (e.g., current and/or voltage consumption information) sensed by the one or more sensors to the communication hub device. The smart circuit breaker may perform substantially similar power consumption related operations as the smart plugs discussed above. For instance, the power consumption application on the communication hub device may establish wireless communication links with respective ones of the smart circuit breakers. The power consumption application may receive a mapping between the plurality of home appliances and the plurality of smart circuit breakers based on respective electric couplings. The power consumption application may receive, from the one or more sensors at individual ones of the smart circuit breakers, sensing data including at least one of current or voltage consumption information. The power consumption application may associate each of the plurality of home appliances with respective sensing data based on the received mapping. The power consumption application may calculate power consumption information for each of the plurality of home appliances based on the respective sensing data. The power consumption application may display, via a UI (e.g., a web application on a user's mobile device or a web portal associated with the communication hub device), the power consumption information for each of the electrical appliances. The power consumption application may detect an anomaly using substantially the same mechanisms as discussed above for the smart plugs.

Generally, a home may include at least one of a smart plug or a smart circuit breaker with sensors that can sense electric current and/or voltage consumption and wireless communication devices that can communicate the sensing data to a communication hub device. In some instances, the home may also include smart electrical appliances with smart sensing modules that have electric current and/or voltage sensing and wireless communication capabilities, and the communication hub device may collect current and/or voltage consumption information from those smart electrical appliances (or more specifically the smart sensing modules within the smart electrical appliances) in a substantially similar way as from the smart plugs and/or smart circuit breakers discussed above. In some instances, the home may also include electrical appliances that are operated by batteries with smart sensing modules that have electric current and/or voltage sensing and wireless communication capabilities, and the communication hub device may collect current and/or voltage consumption information from those batteries (or more specifically the smart sensing modules at those batteries) in a substantially similar way as from the smart plugs and/or smart circuit breakers discussed above.

In some embodiments, a smart plug may be electrically connected to multiple electrical appliances. Depending on the sensing circuitries of the smart plug, the smart plug may be able to sense and report current and/or voltage consumption for each connected electrical appliance. For instance, the smart plug may be a smart plug strip or smart plug tap. In other instances, the different electrical appliances connected to the smart plug may draw different amounts of current and may be powered on at different times, and thus the smart plug may differentiate the different connected electrical appliances based on their respective current consumption and/or power schedules. Similarly, a smart circuit breaker may be electrically coupled to multiple electrical appliances and the smart circuit breaker may use similar mechanisms as the smart plug to sense and report current and/or voltage consumption for each connected electrical appliance.

In some embodiments, the communication hub device may be a fixed wireless access point that communicates with electrical metering-capable devices (e.g., including smart plugs, smart circuit breakers, smart electrical appliances, and smart batteries, etc.) via WiFi and communicates with other networks (e.g., the Internet) via a wireless cellular network (e.g., third-generation (3G), fourth-generation (4G), fifth-generation (5G), or any further generations as defined by third generation partnership project (3GPP) or any other suitable wireless communication protocols). In some embodiments, the power consumption application may be provided as part of a home Internet service offered by a telecommunications network provider. In some embodiments, the telecommunications network provider may partner with utility companies to provide further power monitoring and/or controls with user consent. In some instances, the power consumption application may be allowed to modify the power setting of an electrical appliance (e.g., to modify a temperature setting of an air-conditioner during a hot summer day or a cold winter day for electric load balancing).

Utilizing smart plugs and/or smart breakers equipped with electric current and/or voltage sensing and wireless communication capabilities at a home and integrating collection, monitoring, and/or analysis of power consumption information as part of a home networking service at a home network router (e.g., a communication hub device) can provide users with useful power consumption information by individual electrical appliances. For instance, a user may compare per electrical appliance power usage statistics collected at the user's home with power usage statistics and/or charges provided by their electric utility provider. The per electrical appliance power consumption information may enable the user to more effectively reduce their electrical usage and/or monitor for faulty conditions (e.g., electrical appliance with degrading performances and/or increase in power consumption for certain electrical appliance(s) compared to past power consumption data or other consumer information). Allowing a user to configure mapping information between the electrical appliances and the smart plugs and/or the smart circuit breakers provides the user with flexibility in naming those electrical appliances and obtaining useful power consumption information for each named electrical appliance. Providing candidate electrical appliances for each smart plug or smart circuity breaker based on current and/or power usage pattern analysis (e.g., using ML) may further ease the user in selecting and configuring the mapping information.

Monitoring for an upcoming or potential current overload condition in a particular circuit and initiating an action to switch off a power supply to that circuit can avoid the occurrence of the current overload condition and/or damages to electrical appliance(s) connected to that circuit. Monitoring and notifying a user of a GFCI circuit trip can allow the user to quickly take a corrective action (e.g., reset the GFCI circuit) instead of going through various troubleshooting to determine that the GFCI circuit is tripped. This can be especially helpful as not all users are knowledgeable about electric circuits and/or GFCI circuits. Monitoring and notifying a user of a power consumption that deviates from a norm may enable the user to quickly take a corrective action (e.g., to modify a power setting or replace a corresponding electrical appliance) to reduce power usage. Predicting a potential increase in billing for an upcoming billing cycle and notifying a user prior to the end of the billing cycle may enable the user to manage their expectation on electric expenses instead of having a bill shock when the electric bill arrives. Having individual electrical appliance power consumption information can also facilitate partnering with utility companies to facilitate balancing electric load and/or taking advantage of certain discounted rates at certain times (e.g., controlling power settings of particular electrical appliance(s) with user consents). While the present disclosure is discussed in the context of a home environment, the mechanisms for power consumption collection, monitoring, and analysis by individual electrical appliances discussed herein can be applied to any suitable facilities.

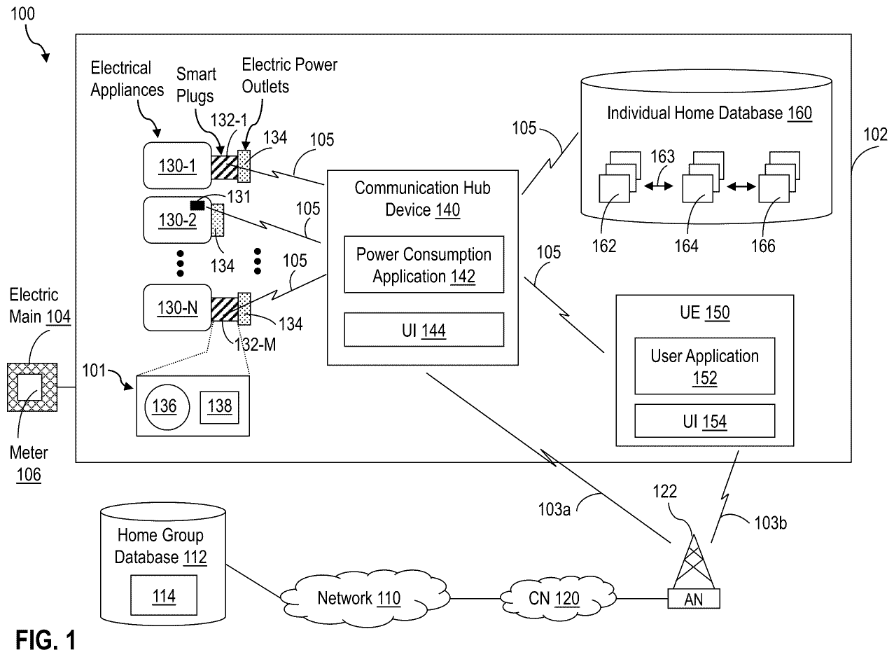

Turning now to FIG. 1, a home environment 100 that supports monitoring and analysis of power consumption by individual electrical appliances 130 is described. The home environment 100 may include a building structure 102 (e.g., a house or any facility). An electric main 104 may supply power from a utility provider to the building structure 102. The building structure 102 may include electric power outlets 134 that are electrically coupled to the electric main 104 so that power may be accessed via the electric power outlets 134. The utility provider may install a meter 106 at the electric main 104 to measure how much electricity is consumed by electrical appliances 130 in the building structure 102. However, the utility provider may only provide total power usage information and not by individual sections (or bays) of the building structure 102 or by individual electrical appliances 130. To facilitate monitoring and analysis of power consumption of individual electrical appliances 130, the home environment 100 may utilize smart plugs 132 equipped with electric current and/or voltage sensing and wireless communication capabilities.

As shown in FIG. 1, the building structure 102 may include a plurality of electrical appliances 130 (e.g., individually shown as 130-1, 130-2, . . . , 130-N, where N may be any suitable integer value), a plurality of smart plugs 132 (e.g., individually shown as 132-1, . . . , 132-M, where M may be any suitable integer value), and a communication hub device 140 (e.g., a network router). The electrical appliances 130 may be any machines, devices, or equipment that are operated by electricity to perform certain tasks. In some instances, the electrical appliances 130 may be referred to as home appliances. Examples of electrical appliances 130 may include, but are not limited to, refrigerators, washing machines, dryers, dishwashers, ovens, microwaves, televisions, air conditioners, heaters, fans, toasters, toaster ovens, coffee makers, blenders, lights, hairdryers, computers, laptops, Internet of Things (IoT) devices, and speakers with networking capabilities (e.g., WiFi speakers).

The smart plugs 132 are devices that may be coupled between standard electric wall outlets (e.g., electric power outlets 134) and electrical appliances 130 to facilitate individual electrical appliance power consumption information collection. Each smart plug 132 may include one or more sensors 136 and a wireless communication device 138 (e.g., as shown by the expanded view 101 for the smart plug 132-M). The one or more sensors 136 may sense at least one of an electric current or an electric voltage. For instance, the one or more sensors 136 may include a current sensor that detects and measures electric current in a circuit and converts the current measurements to a readable signal. Examples of current sensors may include, but are not limited to, hall effect current sensors, current shunt sensors, current transformers, and Rogowski coils. Generally, a current sensor may include any suitable circuitries configured for measuring current consumption. Additionally or alternatively, the one or more sensors 136 may include a voltage sensor that detects and measures electric voltage in a circuit and converts the voltage measurements to a readable signal. Examples of voltage sensors may include, but are not limited to, resistive voltage dividers, capacitive voltage sensors, hall effect voltage sensors, and optically isolated voltage sensors. Generally, a voltage sensor may include any suitable circuitries configured for measuring voltage consumption. In some instances, the sensors 136 at a smart plug 132 may include a sensing meter integrated circuit (IC) configured to monitor current and voltage. In some instances, the wireless communication device 138 at a smart plug 132 may include a certain wireless communication technology chipset or module (e.g., a WiFi chipset when the wireless communication links 105 are WiFi links),

At each smart plug 132, the one or more sensors 136 may provide the sensing data carrying current and/or voltage measurements (measured by the sensors 136) to the wireless communication device 138, and the wireless communication device 138 may wirelessly communicate with the communication hub device 140 via a wireless communication link 105. For instance, the wireless communication device 138 may transmit the sensing data to the communication hub device 140. Generally, a smart plug 132 may also include circuitries for controlling a power state (e.g., for powering on, powering off, or controlling the flow of electric power at certain increments) of an electrical appliance 130 that is plugged into the smart plug 132, a processor (e.g., an embedded chip, such as Raspberry Pi, Arduino, Intel 8051, etc.) that may configure the sensors 136 and/or the wireless communication device 138, and memory for storing sensing data acquired by the sensors 136.

The electrical appliances 130 may include traditional electrical appliances and smart electrical appliances. A traditional electrical appliance 130 may not have built-in current and/or voltage sensors (e.g., the sensors 136) and/or a built-in wireless communication device (the wireless communication device 138). In the illustrated example of FIG. 1, the electrical appliances 130-1 and 130-N are traditional electrical appliances. To facilitate monitoring and analysis of power consumption of a traditional electrical appliance 130, the traditional electrical appliance 130 may be plugged into a smart plug 132, and the smart plugs 132 may be plugged into an electric power outlet 134. Stated differently, a traditional electrical appliance 130 may be electrically coupled to an electric power outlet 134 via a smart plug 132. In this way, the sensor(s) 136 at the smart plug 132 may sense or measure the current and/or voltage consumption of the traditional electrical appliance 130, and the wireless communication device 138 at the smart plug 132 may communicate the current and/or voltage consumption information of the traditional electrical appliance 130 to the communication hub device 140 (e.g., via a wireless communication link 105). In some instances, a smart plug 132 may be in the form of a smart plug tap or a smart plug strip, which is a single unit with multiple sockets, allowing multiple electrical appliances 130 to be plugged into the smart plug 132 (e.g., one electrical appliance 130 plugged into each socket). In such a configuration, the sensors 136 at the smart plug 132 may be able to measure current and/or voltage consumption of each individual electrical appliance 130 that is plugged into a socket of the smart plug 132, and the wireless communication device 138 may communicate the current and/or voltage consumption of each individual electrical appliance 130 with the communication hub device 140.

On the other hand, a smart electrical appliance 130 may be equipped with built-in current and/or voltage sensors (e.g., similar to the sensors 136) and a wireless communication device (e.g., similar to the wireless communication device 138). As such, the smart electrical appliance 130 may be directly plugged into an electric power outlet 134 without a smart plug 132. In the illustrated example of FIG. 1, the electrical appliances 130-2 is a smart electrical appliance including a smart sensing module 131 with built-in current and/or voltage sensors and a wireless communication device. The current and/or voltage consumption of the smart electrical appliance 130-2 may be measured by the built-in sensors, and the current and/or voltage consumption information of the smart electrical appliance 130-2 may be transmitted to the communication hub device 140 by the built-in wireless communication device (e.g., via a wireless communication link 105). In certain examples, the wireless communication links 105 may be WiFi links. That is, the smart plugs 132 and/or the smart electrical appliance 130 (e.g., the electrical appliance 130-2) are WiFi devices and may communicate with the communication hub device 140 according to the IEEE 802.11 wireless communication protocol. Generally, the smart plugs 132 and/or the smart electrical appliance 130 (e.g., the electrical appliance 130-2) may communicate with the communication hub device 140 using any suitable wireless communication protocols.

The communication hub device 140 is a network router (e.g., a fixed wireless access point) including processor(s) and a non-transitory memory, and a power consumption application 142 including instructions stored at the non-transitory memory and executable by the processor(s). The power consumption application 142 may establish wireless communication links 105 with smart plugs 132 and/or smart electrical appliances 130 (e.g., the electrical appliance 130-2). As part of establishing the wireless communication links 105, the power consumption application 142 may acquire device information (e.g., serial numbers) associated with the smart plugs 132 and assign an Internet protocol (IP) address to each smart plug 132. The power consumption application 142 may store the device information in association with the IP address information of the smart plugs 132 as smart plug information 162 in an individual home database 160. In an example, the individual home database 160 may be stored in a storage device in wireless communication with the communication hub device 140 via a wireless communication link 105 as shown in FIG. 1. In other examples, the individual home database 160 may be stored at local memory of the communication hub device 140 or in a storage device that is directly connected to the communication hub device 140 (e.g., via a universal serial bus (USB) connection).

The power consumption application 142 may also acquire mappings 163 between the electrical appliances 130 and the smart plugs 132 (e.g., as part of the wireless connection establishment or after the wireless connection establishment). As an example, the mappings 163 may indicate that the electrical appliance 130-1 is an oven (e.g., a device name) and is connected to the smart plug 132-1 and the electrical appliance 130-N is a washing machine (e.g., a device name) and is connected to the smart plug 132-M. The power consumption application 142 may acquire the mappings 163 from a user (of the home environment 100) via a UI 144. In an example, the UI 144 may be a web portal, and the user may log into the web portal to configure the mappings 163. As will be discussed more fully below, the power consumption application 142 may apply ML processing to assist the user in configuring the mappings 163. In some instances, the power consumption application 142 may also acquire device information (e.g., device names and/or other device specification information) associated with the electrical appliances 130. The power consumption application 142 may store the device information of the electrical appliances 130 as electric appliance information 164 in association with corresponding mappings 163 to the smart plugs 132 in the individual home database 160.

The power consumption application 142 may receive current and/or voltage consumption information from each smart plug 132 and may associate the current and/or voltage consumption information with a respective electrical appliance 130 based on the mappings 163. As an example, the power consumption application 142 may receive first current and/or voltage consumption information from the smart plug 132-1 and second current and/or voltage consumption information from the smart plug 132-M. Based on the mappings 163, the power consumption application 142 may associate the first current and/or voltage consumption information with the electrical appliance 130-1 and may associate the second current and/or voltage consumption information with the electrical appliance 130-N. The power consumption application 142 may calculate power consumption information 166 for each individual electrical appliance 130 based on current and/or voltage consumption information received from respective smart plugs 132. The power consumption application 142 may also receive current and/or voltage consumption information about each smart electrical appliance 130 (e.g., the electrical appliance 130-2) from the respective smart electrical appliance 130 over a respective wireless communication link 105. Generally, the power consumption application 142 may receive current and/or voltage consumption information of each individual electrical appliance 130 periodically (e.g., per minute, per 10 minutes, per 30 minutes, per hour, or per any suitable time period) and calculate power consumption information 166 or statistics for each individual electrical appliance 130. The power consumption application 142 may store the power consumption information 166 for each individual electrical appliance 130 in associations with the respective electrical appliance information 164 in the individual home database 160. Generally, the power consumption application 142 may calculate maximum, minimum, and/or average power consumption over a given period (e.g., a day, a month, a year, etc.) for each electrical appliance 130.

The power consumption application 142 may display the calculated power consumption information 166 for each individual electrical appliance 130 on the UI 144. As discussed above, the UI 144 may be a web portal, and thus a user (of the home environment 100) may log into the web portal to review the power consumption information for the individual electrical appliance 130. The power consumption application 142 may monitor the power consumption information of the individual electrical appliances 130 and generate alerts or initiate various actions upon detecting some predetermined special conditions (e.g., anomalies with the power consumption of the electrical appliances 130).

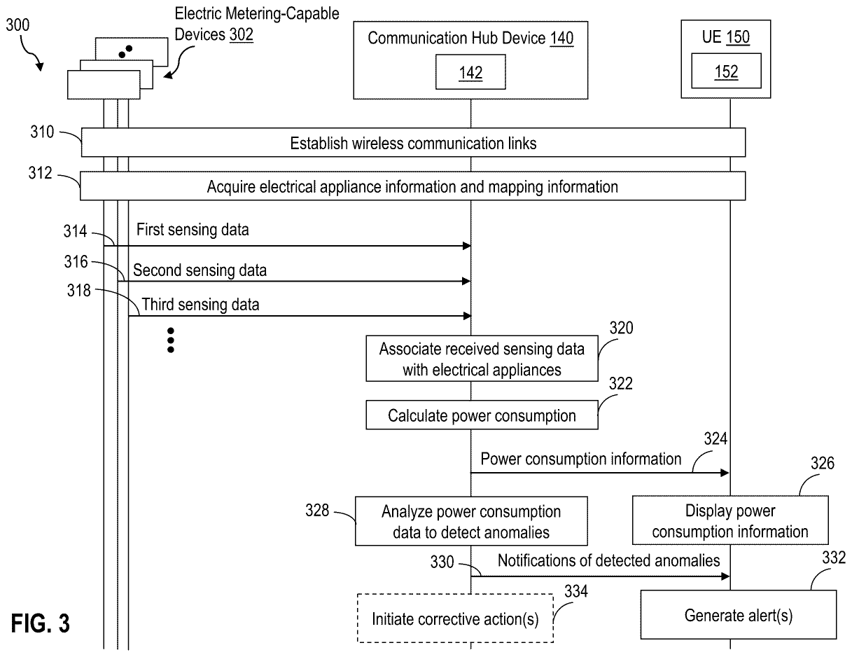

In an example, a special condition may be associated with a detection of a potential current overload condition. In another example, a smart plug 132 may be plugged into an electric power outlet 134 that includes GFCI circuitries and a special condition may be associated with a detection of a GFCI being tripped. In yet another example, a special condition may be based on a comparison between the power consumption information 166 of the home environment 100 for a current period (billing period) to past power consumption information 166 in previous periods (previous billing periods) stored in individual home database 160. In a further example, a special condition may be based on a comparison of the power consumption information 166 of the home environment 100 with other consumer power consumption information 114 (e.g., of neighboring homes having similar type of electrical appliances 130 as the home environment 100) stored in a home group database 112. The other consumer power consumption information 114 may include maximum, minimum, and/or average power consumption (e.g., in kWh) for various types of electrical appliances 130 and/or the same type of electrical appliances 130 from various different manufacturers. Mechanisms for monitoring and analyzing power consumption information of the electrical appliances 130 using smart plugs 132 will be discussed more fully with reference to FIGS. 3-6 and 8.

As further shown in FIG. 1, the home environment 100 may include a UE 150. The UE 150 may be a cell phone, a mobile phone, a smart phone, a personal digital assistant (PDA), an IoT device, a wearable computer, a headset computer, a laptop computer, a tablet computer, a notebook computer, embedded wireless modules, and/or other wirelessly equipped communication devices (whether or not user operated). In some examples, a UE 150 may be a wearable computer embedded in or in the form of a wearable goggle, a wearable eyeglass, or a wearable headset. In an embodiment, a user (e.g., of the home environment 100) may access the power consumption information of the individual electrical appliances 130 via a user application 152 executing on the UE 150. For instance, the user application 152 may be a web application, and the power consumption application 142 may establish a wireless communication link 105 with the UE 150 and transmit the power consumption information 166 of the individual electrical appliances 130 to the user application 152 over the established wireless communication link 105 for display on a UI 154 at the UE 150. As will be discussed more fully below, the user may also configure the mappings 163 between the electrical appliances 130 and the smart plugs 132 via the UI 154 at the UE 150.

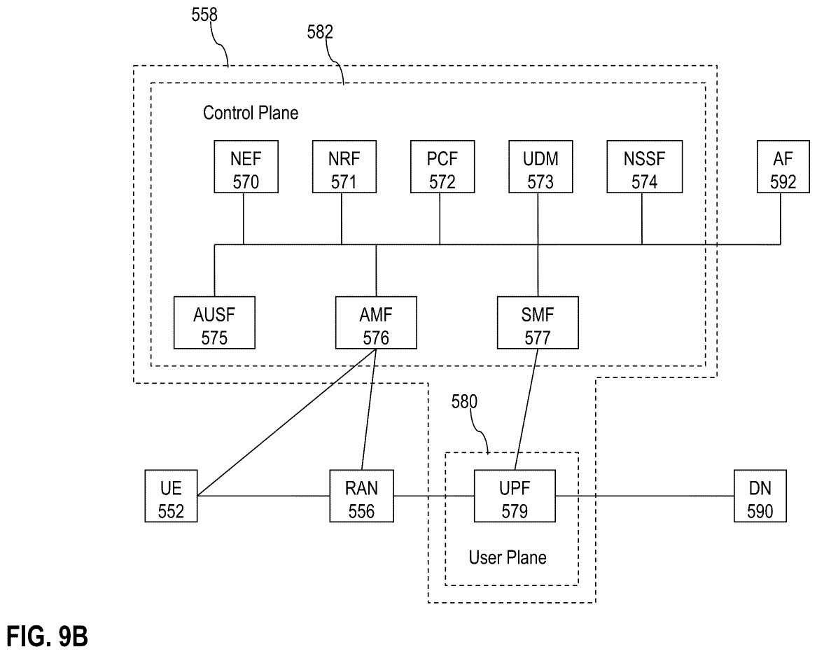

As further shown in FIG. 1, the communication hub device 140 and the UE 150 may communicate with a cell site 122 respectively via wireless communication links 105 and 103b, where a core network (CN) 120 may couple the cell site 122 to a network 110. The cell site 122 providing wireless communications to the UE 150 and the communication hub device 140 may form an access network, which may be referred to as a radio access network in some context. In some examples, the wireless communication links 105 may be established according to a 5G, a long-term evolution (LTE), a code division multiple access (CDMA), a global system for mobile communications (GSM) wireless telecommunication protocol, or some other suitable cellular communication protocol. In 5G technology, an AN may be referred to as a next Generation Node B (gNB). In LTE technology, an AN may be referred to as an evolved Node B (eNB). In CDMA and GSM technology, an AN may be referred to as a base transceiver station (BTS) combined with a base station controller (BSC). In some contexts, an AN may be referred to as a cell tower. The CN 120 may provide various network functions, such as access and security management, subscriber authentication, quality of service management, routing and communication control, interconnection with other networks. An example of a 5G network is discussed below with reference to FIGS. 9A and 9B. The network 110 may include one or more public networks, one or more private networks, or a combination thereof. In some examples, the network 110 may include the Internet.

Generally, a user of the UE 150 may communicate with the communication hub device 140 (e.g., to configure mappings 163 between the smart plugs 132 and the electrical appliances 130, view power consumption information of the individual electrical appliances 130, or receive alerts or notifications of certain special conditions) via a wireless communication link 105 (e.g., a WiFi link) and/or via a wireless communication link 103 (e.g., a cellular link). For instance, when the UE 150 is within the building structure 102 or within the range of the communication hub device 140, the UE 150 may communicate with the communication hub device 140 via the wireless communication link 105. Alternatively, when the UE 150 is outside of the building structure 102 or out of the range of the communication hub device 140, the UE 150 may communicate with the communication hub device 140 via the wireless communication link 105.

As further shown in FIG. 1, the home group database 112 is connected to the network 110. As such, the power consumption application 142 may access the home group database 112 via the cell site 122, the CN 120, and the network 110. In some embodiments, the power consumption application 142 may be provided as part of a home Internet service offered by a telecommunications network provider. For instance, the wireless communication links 105 in the home environment 100 may be part of a home network. Stated differently, the communication hub device 140, the smart plugs 132, and the UE 150 may establish a home network in the home environment 100. In some embodiments, the telecommunications network provider may partner with utility providers to provide further power monitoring and/or controls with user consent. In such embodiments, the home group database 112 may be associated with a utility provider. For instance, the utility provider may collect power usage statistics of various electrical appliances 130 from its customers (e.g., based on consents from the customers) and the power consumption information 114 may be based on the statistics collected by the utility provider.

FIG. 1 is merely an example of components of a home environment 100, and variations are contemplated to be within the scope of the present disclosure. In some embodiments, the home environment 100 may include other components not illustrated in FIG. 1. In some embodiments, the home environment 100 may not include every component illustrated in FIG. 1. In some embodiments, the components and connections may be implemented with different connections than those illustrated in FIG. 1. For instance, while FIG. 1 is discussed in the context where all electrical appliances 130 are located inside the building structure 102, the home environment 100 may include electrical appliances 130 (e.g., pool pumps, pool heaters, air-conditioners, etc.) outside the building structure 102 and similar power consumption monitoring and analysis mechanisms may be applied to those electrical appliances 130 that are outside. Such and other embodiments are contemplated to be within the scope of the present disclosure.

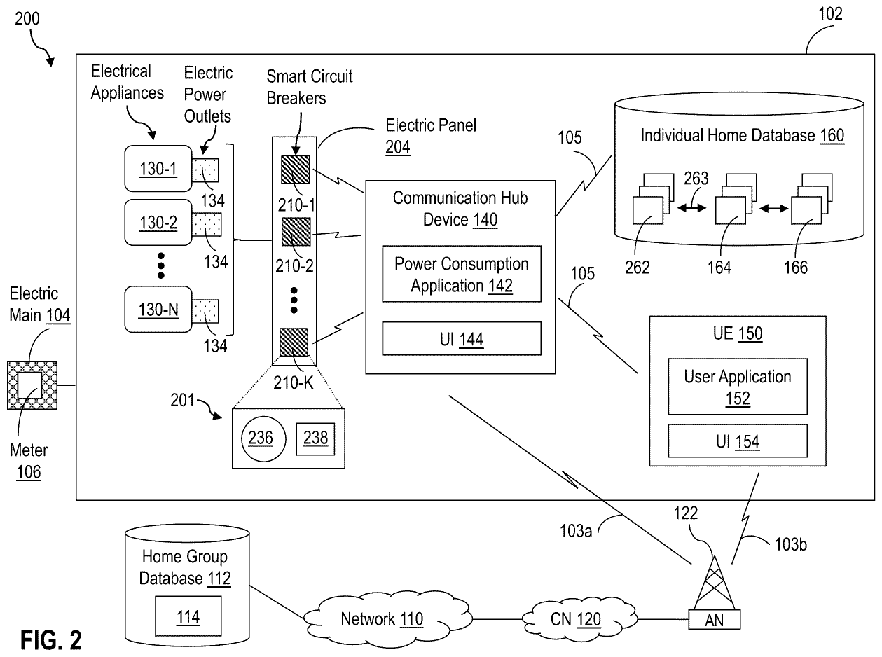

Turning now to FIG. 2, a home environment 200 that supports monitoring and analysis of power consumption by individual electrical appliances 130 is described. The home environment 200 may be substantially similar to the home environment 100 of FIG. 1. However, the home environment 200 may utilize smart circuit breakers 210 equipped with electric current and/or voltage sensing and wireless communication capabilities to facilitate monitoring and analysis of power consumption of individual electrical appliances 130 instead of utilizing smart plugs 132 as in the home environment 100. As shown in FIG. 2, the building structure 102 may include an electric panel 204 (e.g., a distribution panel or a switch board) and a plurality of smart circuit breakers 210 (individually shown as 210-1, 210-2, . . . , 210-K, where K may be any suitable integer value) on the electric panel 204. The smart circuit breakers 210 may couple the electric main 104 to the electric power outlets 134 in the home environment 200, and the electrical appliances 130 may be plugged into the electric power outlets 134. Stated differently, the smart circuit breakers 210 may electrically couple the electric main 104 to the electrical appliances 130.

The smart circuit breaker 210 may include safety circuitries that are substantially the same as in traditional circuit breakers. For instance, the safety circuitries may be configured to automatically shut off power to a particular circuit in the home environment 200 when that particular circuit is overloaded or when there is a short circuit. However, each smart circuit breaker 210 may further include one or more sensors 236 and a wireless communication device 238 as shown by the expanded view 201 for the smart circuit breaker 210-K. The one or more sensors 236 may be substantially similar to the sensors 136. For instance, the one or more sensors 236 may include current sensor(s) and/or voltage sensor(s) to measure current and/or voltage consumption of individual electrical appliances 130 that are electrically coupled to the smart circuit breaker 210. The wireless communication device 238 may be substantially similar to the wireless communication device 138. At each smart circuit breaker 210, the one or more sensors 236 may provide sensing data carrying current and/or voltage measurements (measured by the sensors 236) to the wireless communication device 238, and the wireless communication device 238 may wirelessly communicate with the communication hub device 140 via a wireless communication link 105. For instance, the wireless communication device 238 may transmit the sensing data to the communication hub device 140. As discussed above, in certain examples, the wireless communication links 105 may be WiFi links. In such examples, the smart circuit breakers 210 are WiFi devices and may communicate with the communication hub device 140 according to the IEEE 802.11 wireless communication protocol. Generally, a smart circuit breaker 210 may also include a processor (e.g., an embedded chip, such as Raspberry Pi, Arduino, Intel 8051, etc.) configured to configure the sensors 236 and/or the wireless communication device 238 and memory for storing sensing data acquired by the sensors 236. In other instances, the electric panel 204 may include memory for storing the sensing data acquired by the sensors 236 of the individual smart circuit breakers 210.

In the home environment 200, the power consumption application 142 at the communication hub device 140 may communicate with the smart circuit breakers 210 using substantially similar mechanisms as with the smart plugs 132 in the home environment 100. For instance, the power consumption application 142 may establish wireless communication links 105 with respective ones of the smart circuit breakers 210. The power consumption application 142 may acquire device information (e.g., serial numbers) about the smart circuit breakers 210, assign IP addresses to the smart circuit breakers 210. The power consumption application 142 may store the device information in association with the IP address information of the smart circuit breakers 210 as smart circuit breaker information 262 in the individual home database 160. The power consumption application 142 may receive mappings 263 between the electrical appliances 130 and the smart circuit breakers 210 (e.g., based on user input and/or ML processing as will be discussed more fully below). As an example, the mappings 263 may indicate that the electrical appliance 130-1 is an oven (e.g., a device name) and is connected to the smart circuit breaker 210-1 and the electrical appliance 130-N is a washing machine (e.g., a device name) and is connected to the smart circuit breaker 210-2. The power consumption application 142 may store device information of the electrical appliances 130 as electrical appliance information 164 in association with corresponding mappings 263 to the smart circuit breakers 210.

The power consumption application 142 may receive, from the one or more sensors 236 at individual ones of the smart circuit breakers 210, sensing data including at least one of current or voltage consumption information. The power consumption application 142 may associate each of the plurality of electrical appliances 130 with respective sensing data based on the received mappings 263. The power consumption application 142 may calculate power consumption information 166 for each of the plurality of electrical appliances 130 based on the respective sensing data. The power consumption application 142 may display, via the UI 144 at the communication hub device 140 or the UI 154 at the UE 150, the power consumption information 166 for each of the electrical appliances 130. The power consumption application 142 may analyze the power consumption information 166 to monitor for anomalies (e.g., a current overload, a tripped GFCI, a projected power consumption of an electrical appliance 130 deviating from past power consumption data or other consumers power consumption data). Upon detecting an anomaly, the power consumption application 142 may initiate an action to report the detected anomaly and/or resolve the detected anomaly. Mechanisms for monitoring and analyzing power consumption information of the electrical appliances 130 using smart circuit breakers 210 will be discussed more fully with reference to FIGS. 3-7.

FIG. 2 is merely an example of components of a home environment 200, and variations are contemplated to be within the scope of the present disclosure. In some embodiments, the home environment 200 may include other components not illustrated in FIG. 2. In some embodiments, the home environment 200 may not include every component illustrated in FIG. 2. In some embodiments, the components and connections may be implemented with different connections than those illustrated in FIG. 2. For instance, while FIG. 2 is discussed in the context where all electrical appliances 130 are located inside the building structure 102, the home environment 100 may include electrical appliances 130 (e.g., pool pumps, pool heaters, air-conditioners, etc.) outside the building structure 102 and similar power consumption monitoring and analysis mechanisms may be applied to those electrical appliances 130 that are outside. Such and other embodiments are contemplated to be within the scope of the present disclosure.

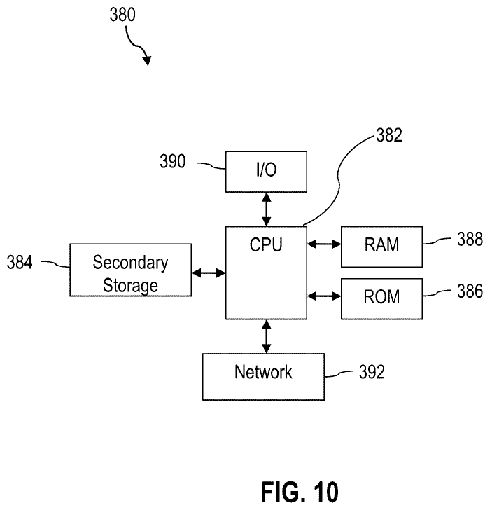

Turning now to FIG. 3, a method 300 of collecting, monitoring, and analyzing power consumption by individual electrical appliances 130 is described. The method 300 illustrates operations performed by various components of the home environments 100 and 200. Specifically, the components include smart plugs 132 and/or smart circuit breakers 210, which may generally be referred to as electric metering-capable devices 302, the communication hub device 140, and the UE 150. However, it is contemplated that other component(s) of the home environments 100 and/or 200 may be involved in performing the operations of the method 300. In some embodiments, each of electric metering-capable device 302, the communication hub device 140, and the UE 150 may implement the operations of the method 300 using a computer system with components as shown in FIG. 10. As illustrated, FIG. 3 includes a number of enumerated operations, but embodiments of the operations in FIG. 3 may include additional operations before, after, and in between the enumerated operations. In some embodiments, one or more of the enumerated operations may be omitted or performed in a different order.

At operation 310, a power consumption application 142 executing on the communication hub device 140 may establish wireless communication links 105 with the electric metering-capable device 302. In some instances, the electric metering-capable device 302 may correspond to the smart plugs 132 shown in FIG. 1. In some instances, the electric metering-capable device 302 may correspond to the smart circuit breakers 210 shown in FIG. 2. In some instances, the electric metering-capable device 302 may include a combination of smart plugs 132 and smart circuit breakers 210. In any case, the electric metering-capable devices 302 may be electrically coupled to electrical appliances 130 in a home environment 100 or 200. The establishing of the wireless communication links 105 may include device discovery (e.g., network discovery by the electric metering-capable devices 302), authentication (e.g., checking security and compatibility), and association between the communication hub device 140 and the electric metering-capable devices 302.

In an example, to setup an electric metering-capable device 302, a user (of a home environment 100 or 200) may plug the electric metering-capable device 302 to an electric power outlet 134 if the electric metering-capable device 302 is a smart plug 132 or activate the electric metering-capable device 302 if the electric metering-capable device 302 is a smart circuit breaker 210. The user may log onto a web portal (e.g., via a UI 144) at the communication hub device 140 to register the electric metering-capable device 302 with a home wireless network (e.g., WiFi network) associated with the communication hub device 140. Alternatively, the user may register the electric metering-capable device 302 with the communication hub device 140 via a web application (e.g., the user application 152 with the UI 154) at the UE 150. The user may be requested to input an access identifier (ID) and/or a password as part of the registration. In some instances, the power consumption application 142 may acquire device information (e.g., device serial number) associated with electric metering-capable devices 302 and assign an IP address to each electric metering-capable device 302. The power consumption application 142 may store the device serial number and IP address information (e.g., the smart plug information 162 and/or the smart circuit breaker information 262) associated with the electric metering-capable devices 302 in an individual home database 160.

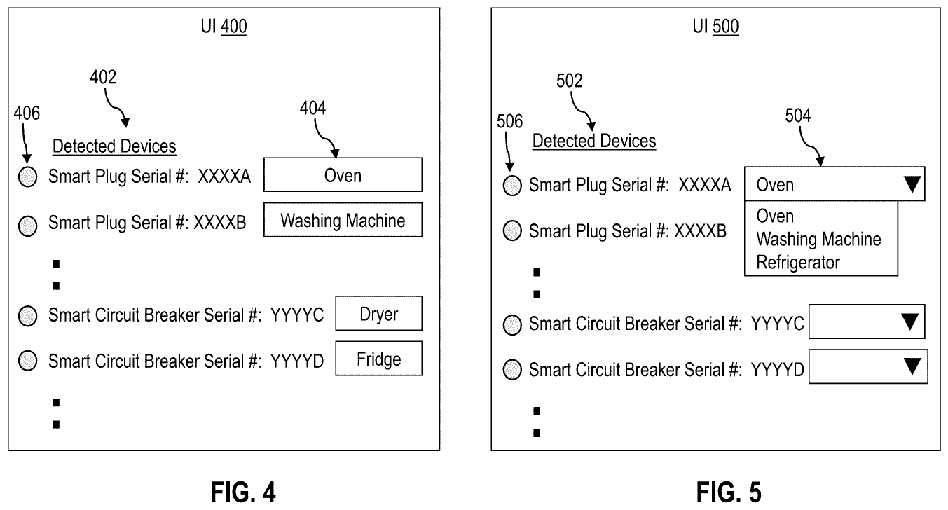

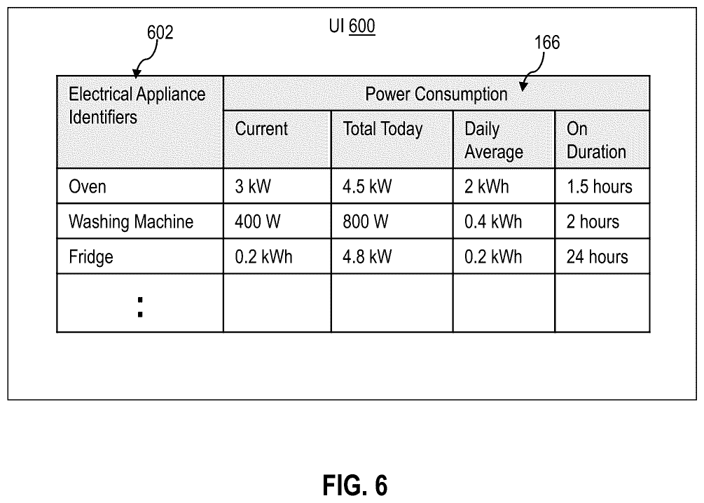

At operation 312, the power consumption application 142 may acquire electrical appliance information 164 associated with the electrical appliances 130 and mapping information (e.g., mappings 163 and/or 263) between the electric metering-capable devices 302 and the electrical appliances 130. The electrical appliance information 164 may include serial numbers of individual electrical appliances 130 and/or device specification information (e.g., maximum, minimum, average power consumption information, etc.). The mapping information may indicate which electrical appliance 130 is connected to which electric metering-capable device 302. The electrical appliance information 164 and the mapping information may be configured by the user via the UI 154 provided by the user application 152 at the UE 150 as shown in FIG. 3. In some other examples, the electrical appliance information 164 and the mapping information may be configured by the user via the UI 144 provided by the power consumption application 142 at the communication hub device 140. FIGS. 4-5 illustrate various examples of UI 144 or 154.

In some instances, the user may also configure, via the UI 144 and/or 154, the frequency of measurements (e.g., a schedule-hourly, daily, etc.) and measurement units for voltage (e.g., Volt (V) values in floating point data type), current (e.g., milliampere (mA) values in floating point data type), and/or power consumption (e.g., kWh in floating point data type). Additionally or alternatively, the user may configure, via the UI 144 and/or 154, a predetermined order of criticality for the electrical appliances 310 (e.g., to enable the power consumption application 142 to prioritize which electrical appliance 310 may be powered off upon detecting an anomaly.)

Turning now to FIG. 4, an example UI 400 (e.g., corresponding to the UI 144 or 154) for configuring mappings 163 and/or 263 to facilitate monitoring and analysis of power consumption information of individual electrical appliances 130 is described. As shown in FIG. 4, the UI 400 may display a list of detected electric metering-capable devices 302 including smart plugs 132 and smart circuit breakers and corresponding serial numbers (shown by 402). The detected electric metering-capable device 302 may be based on respective wireless communication links 105 established with the power consumption application 142 (e.g., at operation 310). The UI 400 may further include an input box 404 for a user to enter a device name (or an electrical appliance identifier) for an electrical appliance 130 that is connected to each respective electric metering-capable device 302. In the illustrated example of FIG. 4, an electrical appliance 130 electrically coupled to the smart plug 132 with the serial number XXXXA is an oven, an electrical appliance 130 electrically coupled to the smart plug 132 with the serial number XXXXB is a washing machine, and so on.

In some instances, the UI 400 may also provide a dropdown list showing a list of manufacturers and model numbers for a corresponding electrical appliance 130 where the user may select. In some instances, for the smart circuit breakers 210, the UI 400 may additionally include an input box (similar to the input box 404) for a user to enter a bay number (e.g., section number) associated with each smart circuit breaker 210. In some instances, the UI 400 may also include radio buttons 406 for a user to opt-in or opt-out power consumption monitoring and analysis for a certain smart plug 132 or a certain smart circuit breaker 210.

FIG. 4 is merely an example of components of a UI 400, and variations are contemplated to be within the scope of the present disclosure. In some embodiments, the UI 400 may include other components not illustrated in FIG. 4. In some embodiments, the UI 400 may not include every component illustrated in FIG. 4. In some embodiments, the components and connections may be implemented with different connections than those illustrated in FIG. 4. For example, in some instances, the detected devices in the UI 400 may include only smart plugs 132 with no smart circuit breaker 210. In other instances, the detected devices in the UI 400 may include only smart circuit breakers 210 with no smart plug 132. Such and other embodiments are contemplated to be within the scope of the present disclosure.

Turning now to FIG. 5, an example UI 500 (e.g., corresponding to the UI 144 or 154) for configuring mapping information 163 and/or 263 to facilitate monitoring and analysis of power consumption information of individual electrical appliances 130 is described. As shown in FIG. 5, the UI 500 may display a list of detected electric metering-capable devices 302 including smart plugs 132 and smart circuit breakers 210 and corresponding serial numbers (shown by 502). The UI 500 may further display a user selectable list of candidate electrical appliance identifiers (e.g., electrical appliance types, such as oven, washing machine, dryer, fridge, microwave ovens, etc.) for each detected electric metering-capable device 302. For ease of illustration, FIG. 5 only shows a dropdown list 504 for the smart plug 132 with the serial number XXXXA.

In an embodiment, the power consumption application 142 may receive current and/or voltage consumption received from the electric metering-capable devices 302, calculate power consumption information associated with each electric metering-capable device 302 (e.g., which is coupled to a certain electrical appliance 130), and analyze the power consumption pattern. For example, a distinctive pattern of consuming electric power may be attributable to specific electrical appliances 130—a refrigerator, an air-conditioner compressor, a blower, an electric dryer, etc. In an embodiment, the power consumption application 142 may perform the power consumption pattern analysis by applying a ML model to the power consumption data. The ML model may be trained to identify electrical appliances based on power consumption data trend (e.g., using gradient algorithm and backpropagation algorithm to tune parameters of the ML model). In some examples, the ML model may output a list of candidate electrical appliances for each electric metering-capable device 302 with corresponding confidence scores, and the UI 500 may list the candidate electrical appliances 130 in the order of the confidence scores (e.g., from the highest score to the lowest score). As an example, the ML model may output a list of candidate electrical appliance identifiers including an oven, a washing machine, and a refrigerator with decreasing confidence scores for the smart plug 132 with the serial number XXXXA.

In some instances, for the smart circuit breakers 210, the UI 500 may additionally include an input box (similar to the input box 404) for a user to enter a bay number (e.g., section number) associated with each smart circuit breaker 210. In some instances, the UI 500 may also include radio buttons 506 for a user to opt-in or opt-out power consumption monitoring and analysis for a certain smart plug 132 or a certain smart circuit breaker 210.

FIG. 5 is merely an example of components of a UI 500, and variations are contemplated to be within the scope of the present disclosure. In some embodiments, the UI 500 may include other components not illustrated in FIG. 5. In some embodiments, the UI 500 may not include every component illustrated in FIG. 5. In some embodiments, the components and connections may be implemented with different connections than those illustrated in FIG. 5. For example, in some instances, the detected devices in the UI 500 may include only smart plugs 130 with no smart circuit breaker 210. In other instances, the detected devices in the UI 500 may include only smart circuit breakers 210 with no smart plug 132. Such and other embodiments are contemplated to be within the scope of the present disclosure. Generally, the UI 154 or 144 may include any suitable combinations of the UI 400 and 500.

Returning to FIG. 3, at operation 314, the power consumption application 142 may receive, from a first electric metering-capable device 302 of the electric metering-capable devices 302, first sensing data including at least one current or voltage consumption information associated with one or more individual electrical appliances 130 that are connected to the first electric metering-capable device 302. At operation 316, the power consumption application 142 may receive, from a second electric metering-capable device 302 of the electric metering-capable devices 302, second sensing data including at least one current or voltage consumption information associated with one or more individual electrical appliances 130 that are connected to the second electric metering-capable device 302. At operation 318, the power consumption application 142 may receive, from a third electric metering-capable device 302 of the electric metering-capable devices 302, third sensing data including at least one current or voltage consumption information associated with one or more individual electrical appliances 130 that are connected to the third electric metering-capable device 302. Generally, the power consumption application 142 may receive, from each electric metering-capable device 302, sensing data associated with electrical appliance(s) 130 connected to respective electric metering-capable device 302 periodically (e.g., per minute, per 10 minutes, per 30 minutes, per hour, or per any suitable time period).

At operation 320, the power consumption application 142 may associate the received sensing data (e.g., the first sensing data received at operation 314, the second sensing data received at operation 316, the third sensing data received at operation 318, and so on) to corresponding electrical appliances 130 based on the mapping information received at operation 314. As an example, the mapping information may indicate that an oven (e.g., a first electrical appliance 130) is connected to the first electric metering-capable device 302, a washing machine (e.g., a second electrical appliance 130) is connected to the second electric metering-capable device 302, and a refrigerator (e.g., a third electrical appliance 130) is connected to the third electric metering-capable device 302. Accordingly, the power consumption application 142 may associate the first sensing data with the oven (the first electrical appliance 130), associate the second sensing data with the washing machine (the second electrical appliance 130), and associate the third sensing data with the refrigerator (the third electrical appliance 130). At operation 322, the power consumption application 142 may calculate power consumption information 166 (e.g., in terms of kWh) for each electrical appliance 130 based on the respective received sensing data (e.g., by multiplying a current measurement with a corresponding voltage measurement associated with the respective electrical appliance 130). In some instances, the power consumption application 142 may store the calculated power consumption information 166 for each electrical appliance 130 in association with corresponding electrical appliances 130 in an individual home database 160.

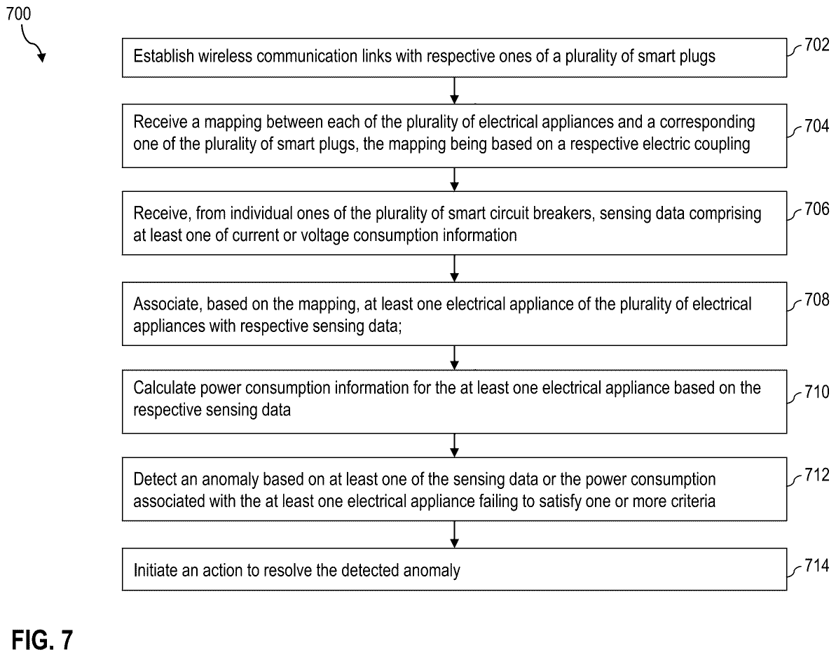

At operation 324, the power consumption application 142 may transmit, to the UE 150, the power consumption information 166 for each individual electrical appliance 130 for display. At operation 326, the user application 152 may display the power consumption information 166 for each individual electrical appliance 130 (e.g., in a table format) via the UI 154. For instance, the user may open the user application 152 (the web application) on the UE 150 and request for the power consumption information 166. In an example, the calculated power consumption information 166 may be displayed for each electrical appliance 130 along with a corresponding electrical appliance name identifier as configured by the user during operation 314 (e.g., in a table format as shown in FIG. 6). In some other instances, the user may log onto the communication hub device 140 and request for the power consumption information 166. Accordingly, the power consumption application 142 may display the power consumption information 166 for each individual electrical appliance 130 via the UI 144. In some instances, the power consumption application 142 may only calculate, store, and/or display power consumption information 166 for the electrical appliance(s) 130 that are opted-in by the user (e.g., via the radio buttons 406 and/or 506 during setup time).

Turning now to FIG. 6, an example UI 600 (e.g., corresponding to the UI 144 or 154) is described. As shown in FIG. 6, the UI 600 may display a table listing the electrical appliances 130 by corresponding electrical appliance identifiers 602 (e.g., device names) as configured by the user during operation 314 and in association with corresponding power consumption information 166. In the illustrated example of FIG. 6, the power consumption information 166 may include a current power consumption (e.g., a real-time reading), a total power consumption for today, a daily average power consumption, a total power consumption for the month, a monthly average power consumption for each electrical appliance 130. In some instances, the UI 600 may further show, for each electrical appliance 130, a corresponding smart plug 132 or smart circuit breaker 210 that is electrically coupled to the respective electrical appliance 130. In some instances, the UI 600 may further display the power usage for each electrical appliance 130 in any suitable granular level (e.g., per 10 minutes, per hour, per day, etc.) over a certain time period (e.g., over a day, a month, a year, etc.) in a graphical format or a tabular format. Generally, the UI 600 may display a maximum, a minimum, and/or an average power consumption for each electrical appliance 130 in a given period.

FIG. 6 is merely an example of components of a UI 600, and variations are contemplated to be within the scope of the present disclosure. In some embodiments, the UI 600 may include other components not illustrated in FIG. 6. In some embodiments, the UI 600 may not include every component illustrated in FIG. 6. In some embodiments, the components and connections may be implemented with different connections than those illustrated in FIG. 6. Such and other embodiments are contemplated to be within the scope of the present disclosure.

Turning back to FIG. 3, at operation 328, the power consumption application 142 may analyze the power consumption information 166 of each electrical appliance 130 to detect anomalies (e.g., predetermined conditions). Examples of anomalies may include, but are not limited to, a potential current overload, a GFCI trip, a power consumption that deviates from a norm (e.g., based on statistics of other consumers), and a potential increase in billing for an upcoming billing period (e.g., based on past billing data). At operation 330, upon detecting an anomaly, the power consumption application 142 may transmit a notification to notify the UE 150 of the detected anomaly. At operation 332, the user application 152 may generate an alert to notify the user of the UE 150. The generated notification may be an audio or a visual alert (e.g., depending on a user configuration). The notification may also indicate a description (a popup message) of the detected anomaly, e.g., specifying whether the anomaly is associated with a current overload and an associated electric metering-capable device 302, a GFCI and an associated electric metering-capable device 302 trip, an electrical appliance 130 with an abnormal power consumption, or a billing increase, etc. At operation 334, in some instances, the power consumption application 142 may initiate a corrective action to resolve the detected anomaly.

In an embodiment, as part of analyzing the sensing data at operation 328, the power consumption application 142 may detect an anomaly associated with a first electrical appliance 130 based on a comparison of the power consumption information 166 for the first electrical appliance 130 with reference power consumption data. In one embodiment, the reference power consumption data used for the comparison may include past power consumption data (e.g., minimum, maximum, or average power consumption) associated with the particular first electrical appliance. For instance, if the newly calculated power consumption information 166 for the first electrical appliance 130 is greater than past power consumption information 166 of the first electrical appliance 130 stored in the individual home database 160 by a certain amount (e.g., a threshold), the power consumption application 142 may determine that an anomaly is detected. In another embodiment, the reference power consumption data used for the comparison may include other power consumption data (e.g., minimum, maximum, or average power consumption) associated with electrical appliances 130 of the same product type (e.g., an oven) as the first electrical appliance 130 (e.g., an oven). The other power consumption data may correspond to the other power consumption information 114 at a home group database 112. In such an embodiment, the power consumption data may be general power consumption information for that product type or power consumption information obtained from neighboring homes having the same type of electrical appliances. Similarly, if the newly calculated power consumption information 166 for the first electrical appliance 130 is greater than the other power consumption information 114 by a certain amount (e.g., a threshold), the power consumption application 142 may determine that an anomaly is detected.

In an embodiment, as part of analyzing the sensing data at operation 328, the power consumption application 142 may predict an electrical billing cost for the home environment based on the sensing data received from the one or more sensors (e.g., the sensors 136 or 236) at the individual ones of the electric metering-capable devices 302. The power consumption application 142 may detect an anomaly based on a comparison of the predicted electrical billing cost and at least one of past electrical billing information associated with the home environment or electrical billing information associated with neighboring homes. For instance, the power consumption application 142 may have information about the rate plan subscribed by the homeowner, thus may predict the amount of power consumed by the home for a current billing period based on usage patterns of the electrical appliances 130 and predict the billing cost based on the rate plan and the predicted power usage. If the power consumption application 142 determines that the predicted billing cost is higher than expected (e.g., greater than an average of pass billing by a certain amount), the power consumption application 142 may determine that an anomaly is detected. In some instances, the power consumption application 142 may only analyze the power consumption information 166 for the electrical appliance(s) 130 that are opted-in by the user (e.g., via the radio buttons 406 and/or 506 during setup time).

In an embodiment, as part of analyzing the sensing data at operation 328, the power consumption application 142 may detect an anomaly based on at least one of the sensing data or the power consumption information 166 associated with a first electrical appliance 130 of the plurality of electrical appliances 130 failing to satisfy one or more criteria. In an example, the detecting the anomaly may include determining that a current load associated with a first electric metering-capable device 302 coupled to the first electrical appliance 130 fails to satisfy a threshold. Accordingly, the initiating the corrective action to resolve the detected anomaly at operation 334 may include instructing the first electric metering-capable device 302 coupled to the first electrical appliance 130 to be switched off or at least operate at a low-power mode (e.g., by transmitting an instruction to the electric metering-capable device 302 to operate in a power off state or low-power mode). In another example, a second electric metering-capable device 302 may be coupled to a GFCI circuit, and the detecting the anomaly at operation 328 may include detecting that the GFCI circuit is tripped. Accordingly, the initiating the corrective action to resolve the detected anomaly at operation 334 may include transmitting a notification to the UE 150 to reset the GFCI circuit.

Generally, when the power consumption application 142 detected an anomaly associated with an electrical appliance 130, the power consumption application 142 may transmit a request to modify a setting associated with the electrical appliance 130 (e.g., power on, power off, a temperature setting if the electrical appliance 130 is an air-conditioner, a heater, or a fridge, a wash cycle setting if the electrical appliance 130 is a washing machine, etc.) or a power on-off schedule for the electrical appliance 130. Generally, the power consumption application 142 may also collect sensing data including current and/or voltage consumption information from smart electrical appliances 130 and/or smart batteries equipped with smart current and/or voltage sensing and wireless communication capabilities, calculate power consumption information for the individual smart electrical appliances 130 and/or individual smart batteries, and analyze the power consumption information to detect anomalies as discussed in the method 300.

In an example scenario, the processor at an electric metering-capable device 302 may be a microcontroller (e.g., MSP430i2040), the sensor (e.g., the sensor 136 or 236) at the electric metering-capable device 302 may be a power metering IC (e.g., RN8209C), and the electrical appliance 130 that is connected to the electric metering-capable device 302 may be a lamp. At initialization, the microcontroller may be configured to communicate with the power metering IC via an input/output interface (e.g., a serial peripheral interface (SPI) or an inter-integrated circuit (I2C) interface) and the power metering IC may be initialized to start measuring voltage and current. The initialization may occur before and/or during the operations 310 and/or 312 of the method 300. The power metering IC may measure the voltage and current flowing to the lamp. The microcontroller may read these measurements periodically (e.g., based on the scheduled configured at operation 312). The microcontroller may process the raw data from the power metering IC to calculate the actual voltage (in V) and current (e.g., in mA). The microcontroller may transmit the processed and/or calculated data to a display or a cloud service for monitoring (e.g., the communication hub device 140). The measuring of the voltage and current flowing to the lamp, reading and processing of the raw data from the power metering IC to calculate the voltage and current, and the transmitting of the processed and/or calculated data to the communication hub device 140 may be performed continuously (e.g., in a loop during the operation 314, 316, and/or 318 of the method 300). In some examples, a software development kit (SDK) with various application programming interfaces (APIs) may be provided to enable these operations.

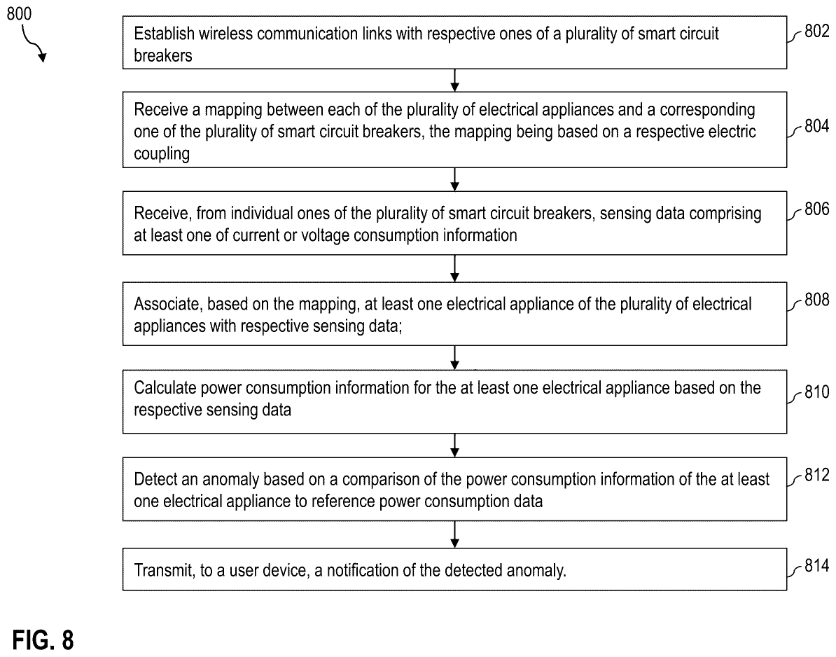

Turning now to FIG. 7, a method 700 is described. In an embodiment, the method 700 is a method of collecting, monitoring, and analyzing power consumption information by individual electrical appliances 130 using smart plugs 132 equipped with current and/or voltage sensing and wireless communication capabilities. The method 700 may be implemented by a power consumption application 142 at a communication hub device 140. The method 700 may include similar mechanisms as discussed above with reference to FIGS. 1 and 3-6. In some embodiments, the method 700 may be implemented using a computer system with components as shown in FIG. 10. As illustrated, FIG. 7 includes a number of enumerated operations, but some embodiments of the operations in FIG. 7 may include additional operations before, after, and in between the enumerated operations. In some embodiments, one or more of the enumerated operations may be omitted or performed in a different order.

At block 702, the power consumption application 142 establishes wireless communication links 105 with respective ones of a plurality of smart plugs 132, each electrically coupled between an electrical power outlet 134 and one or more of a plurality of electrical appliances 130 and includes one or more sensors 136 for sensing at least one of a current or a voltage. In some examples, the smart plugs 132, the electric power outlets 134, and the electrical appliance 130 may be associated with a home environment 100 or 200 or any suitable facility. At block 704, the power consumption application 142 receives a mapping 163 between each of the plurality of electrical appliances 130 and a respective one of the plurality of smart plugs 132, the mapping 163 being based on a respective electrical coupling. For instance, the power consumption application 142 may receive the mapping 163 via a UI as discussed above with reference to FIGS. 4 and 5.

At block 706, the power consumption application 142 receives, from individual ones of the plurality of smart plugs 132, sensing data comprising at least one of current or voltage consumption information. For instance, the power consumption application 142 may receive first sensing data from a first smart plug 132 of the plurality of smart plugs 132, second sensing data from a second smart plug 132 of the plurality of smart plugs 132, third sensing data from a third smart plug 132 of the plurality of smart plugs 132, and so on. In some instances, the power consumption application 142 may receive the sensing data from the individual ones of the plurality of smart plugs 132 based on a periodic time period (e.g., per minute, per 10 minutes, per 30 minutes, per hour, or per any suitable time period).

At block 708, the power consumption application 142 associates, based on the mapping 163, at least one electrical appliance 130 of the plurality of electrical appliances 130 with respective sensing data (received from a corresponding one of the plurality of smart plugs 132 electrically coupled to the at least one electrical appliance 130). At block 710, the power consumption application 142 calculates a power consumption information 166 for the at least one electrical appliance 130 based on the respective sensing data. At block 712, the power consumption application 142 detects an anomaly based on at least one of the sensing data or the power consumption information 166 associated with the at least one electrical appliance 130 fails to satisfy one or more criteria. At block 714, the power consumption application 142 initiates an action to resolve the detected anomaly.

In an embodiment, the detecting the anomaly at block 712 includes determining, based at least in part on the sensing data associated with the at least one electrical appliance 130, that a current load fails to satisfy a threshold (e.g., associated with a current overload condition). In an example, the sensing data associated with the at least one electrical appliance 130 is received from a first smart plug 132 of the plurality of smart plugs 130, and thus the initiating the action to resolve the detected anomaly at block 714 includes transmitting, to the first smart plug 132, an instruction to switch off a power supply to the at least one electrical appliance 130.

In an embodiment, the detecting the anomaly at block 712 includes determining, based at least in part on the sensing data associated with the at least one electrical appliance 130, a GFCI circuit associated with an electric power outlet 134 electrically coupled to the at least one electrical appliance 130 is tripped, and thus the initiating the action to resolve the detected anomaly at block 714 includes transmitting a notification (e.g., to a user device 150) to reset the GFCI circuit. In some instances, the notification may be in the form of a visual notification and/or an audio notification.

In an embodiment, the detecting the anomaly at block 712 includes determining that a difference between a reference power consumption and the calculated power consumption for the at least one electrical appliance 130 exceeds a threshold, and the initiating the action to resolve the detected anomaly at block 714 includes transmitting a request to adjust a power configuration associated with the at least one electrical appliance 130 (e.g., to power off the at least one electrical appliance 130 and/or reduce a power on duration or schedule for the at least one electrical appliance 130). In some instances, the reference power consumption for the comparison includes past power consumption data of the at least one electrical appliance 130 (e.g., past power consumption information 166 stored at an individual home database 160). In some instances, the reference power consumption information for the comparison includes power consumption data associated with the same product type as the at least one electrical appliance 130 (e.g., the power consumption information 114 stored at the home group database 112).

In an embodiment, the power consumption application 142 further receives, via a UI 144 (e.g., a web portal associated with the communication hub device 140) or a UI 154 (e.g., a web application on a user device 150), a power consumption request for the at least one electrical appliance 130. In response, the power consumption application 142 outputs, to the UI 144 or 154, the calculated power consumption of the at least one electrical appliance 130 (e.g., as shown in UI 600 discussed above with reference to FIG. 6).

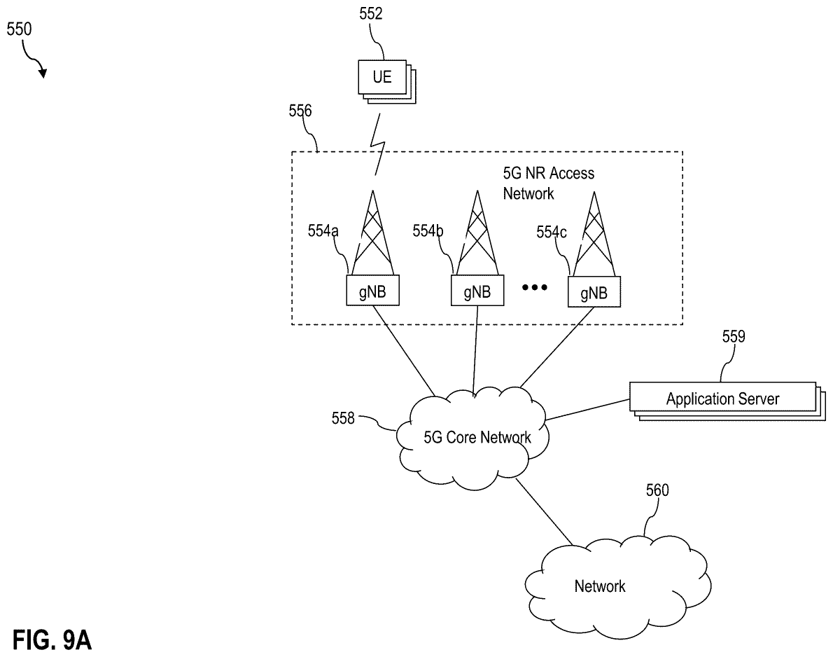

Turning now to FIG. 8, a method 800 is described. In an embodiment, the method 800 is a method of collecting, monitoring, and analyzing power consumption information by individual electrical appliances 130 using smart circuit breakers 210 equipped with current and/or voltage sensing and wireless communication capabilities. The method 800 may be implemented by a power consumption application 142 at a communication hub device 140. The method 800 may include similar mechanisms as discussed above with reference to FIGS. 2-7. In some embodiments, the method 800 may be implemented using a computer system with components as shown in FIG. 10. As illustrated, FIG. 8 includes a number of enumerated operations, but embodiments of the operations in FIG. 8 may include additional operations before, after, and in between the enumerated operations. In some embodiments, one or more of the enumerated operations may be omitted or performed in a different order.

At block 802, the power consumption application 142 establishes wireless communication links 105 with respective ones of a plurality of smart circuit breakers 210. Each of the plurality of smart circuit breakers 210 electrically couples an electric main 104 to one or more of a plurality of electrical appliances 130 and includes one or more sensors 236 for sensing at least one of a current or a voltage. In some examples, the smart circuit breakers 210, the electric main 104, and the electrical appliance 130 may be associated with a home environment 100 or 200 or any suitable facility. At block 804, the power consumption application 142 receives a mapping 263 between each of the plurality of electrical appliances 130 and a corresponding one of the plurality of smart circuit breakers 210, the mapping 263 being based on a respective electric coupling.

At block 806, the power consumption application 142 receives, from individual ones of the plurality of smart circuit breakers 210, sensing data comprising at least one of current or voltage consumption information (sensed by respective sensors 236). For instance, the power consumption application 142 may receive first sensing data from a first smart circuit breaker 210 of the plurality of smart circuit breakers 210, second sensing data from a second smart circuit breaker 210 of the plurality of smart circuit breakers 210, third sensing data from a third smart circuit breaker 210 of the plurality of smart circuit breakers 210, and so on. In some instances, the power consumption application 142 may receive the sensing data from the individual ones of the plurality of smart circuit breakers 210 based on a periodic time period (e.g., per minute, per 10 minutes, per 30 minutes, per hour, or per any suitable time period).

At block 808, the power consumption application 142 associates, based on the mapping 263, at least one electrical appliance 130 of the plurality of electrical appliances 130 with respective sensing data (received from a corresponding one of the plurality of smart circuit breaker 210 electrically coupled to the at least one electrical appliance 130). At block 810, the power consumption application 142 calculates power consumption information 166 for the at least one electrical appliance 130 based on the respective sensing data. At block 812, the power consumption application 142 detects an anomaly based on a comparison of the power consumption information 166 of the at least one electrical appliance 130 to reference power consumption data. In an embodiment, the reference power consumption data used for the comparison to detect the anomaly comprises past power consumption data associated with the at least one electrical appliance 130. In an embodiment, the reference power consumption data used for the comparison to detect the anomaly comprises power consumption data associated with electrical appliances of the same product type as the at least one electrical appliance 130. For instance, if the at least one electrical appliance 130 is an oven, the reference power consumption data for the comparison may be power consumption of other ovens (e.g., of the same manufacturer and/or the same model as the at least one electrical appliance 130 or a different manufacturer and/or a different model than the at least one electrical appliance 130). At block 814, the power consumption application 142 transmits, to a user device 150, a notification of the detected anomaly (e.g., in the form of a visual alert or an audio alert).

In an embodiment, the power consumption application 142 further displays, via a UI 144 (e.g., part of a web portal associated with the communication hub device 140) or a UI 154 (e.g., a web application on the user device 150), an indication of the plurality of smart circuit breakers 210 based on the established wireless communication links 105. In such an embodiment, the mapping 263 is received via the UI 144 or 154 at block 804 in response to the displaying and includes an electrical appliance identifier (e.g., device name) assigned to the at least one electrical appliance 130 and mapped to a corresponding one of the plurality of smart circuit breakers 210 electrically coupled to the at least one electrical appliance 130 (e.g., as shown in the UI 400 and/or 500 discussed above respectively with reference to FIGS. 4 and/or 5). In an embodiment, the power consumption application 142 further displays, via the UI 144 or 154, an indication of the calculated power consumption information 166 for the at least one electrical appliance 130 in association with the electrical appliance identifier assigned to the at least one electrical appliance 130 (e.g., as shown in the UI 600 discussed above with reference to FIG. 6).

In an embodiment, the power consumption application 142 predicts an electrical billing cost based on the sensing data received at block 806 from the individual ones of the plurality of smart circuit breakers 210. For instance, the power consumption application 142 may calculate a power consumption for each of the plurality of electrical appliance 130 based on respective sensing data and calculate the electrical billing cost based on the total power consumption for all of the plurality of electrical appliance 130 and an electricity rate plan subscription associated with the home. The power consumption application 142 further detects a second anomaly based on a comparison of the predicted electrical billing cost and at least one of past electrical billing information associated with the home or electrical billing information associated with neighboring homes. The power consumption application 142 further transmits, to the user device 150, a notification of the detected second anomaly (e.g., in the form of a visual alert or an audio alert).

Turning now to FIG. 9A, an exemplary communication system 550 is described. Typically the communication system 550 includes a number of access nodes 554 that are configured to provide coverage in which UEs 552 such as cell phones, tablet computers, machine-type-communication devices, tracking devices, embedded wireless modules, and/or other wirelessly equipped communication devices (whether or not user operated), can operate. The access nodes 554 may be said to establish an access network 556. The access network 556 may be referred to as a RAN in some contexts. In a 5G technology generation an access node 554 may be referred to as a next Generation Node B (gNB). In 4G technology (e.g., LTE technology) an access node 554 may be referred to as an evolved Node B (eNB). In 3G technology (e.g., code division multiple access (CDMA) and global system for mobile communication (GSM)) an access node 554 may be referred to as a base transceiver station (BTS) combined with a base station controller (BSC). In some contexts, the access node 554 may be referred to as a cell site or a cell tower. In some implementations, a picocell may provide some of the functionality of an access node 554, albeit with a constrained coverage area. Each of these different embodiments of an access node 554 may be considered to provide roughly similar functions in the different technology generations.

In an embodiment, the access network 556 comprises a first access node 554a, a second access node 554b, and a third access node 554c. It is understood that the access network 556 may include any number of access nodes 554. Further, each access node 554 could be coupled with a core network 558 that provides connectivity with various application servers 559 and/or a network 560. In an embodiment, at least some of the application servers 559 may be located close to the network edge (e.g., geographically close to the UE 552 and the end user) to deliver so-called “edge computing.” The network 560 may be one or more private networks, one or more public networks, or a combination thereof. The network 560 may comprise the public switched telephone network (PSTN). The network 560 may comprise the Internet. With this arrangement, a UE 552 within coverage of the access network 556 could engage in air-interface communication with an access node 554 and could thereby communicate via the access node 554 with various application servers and other entities.

The communication system 550 could operate in accordance with a particular radio access technology (RAT), with communications from an access node 554 to UEs 552 defining a downlink or forward link and communications from the UEs 552 to the access node 554 defining an uplink or reverse link. Over the years, the industry has developed various generations of RATs, in a continuous effort to increase available data rate and quality of service for end users. These generations have ranged from “1G,” which used simple analog frequency modulation to facilitate basic voice-call service, to “4G” such as LTE, which now facilitates mobile broadband service using technologies such as orthogonal frequency division multiplexing (OFDM) and multiple input multiple output (MIMO).

Recently, the industry has been exploring developments in “5G” and particularly “5G NR” (5G New Radio), which may use a scalable OFDM air interface, advanced channel coding, massive MIMO, beamforming, mobile mmWave (e.g., frequency bands above 24 GHz), and/or other features, to support higher data rates and countless applications, such as mission-critical services, enhanced mobile broadband, and massive IoT. 5G is hoped to provide virtually unlimited bandwidth on demand, for example providing access on demand to as much as 20 gigabits per second (Gbps) downlink data throughput and as much as 10 Gbps uplink data throughput. Due to the increased bandwidth associated with 5G, it is expected that the new networks will serve, in addition to conventional cell phones, general Internet service providers for laptops and desktop computers, competing with existing ISPs such as cable Internet, and also will make possible new applications in IoT and machine to machine areas.

In accordance with the RAT, each access node 554 could provide service on one or more radio-frequency (RF) carriers, each of which could be frequency division duplex (FDD), with separate frequency channels for downlink and uplink communication, or time division duplex (TDD), with a single frequency channel multiplexed over time between downlink and uplink use. Each such frequency channel could be defined as a specific range of frequency (e.g., in RF spectrum) having a bandwidth and a center frequency and thus extending from a low-end frequency to a high-end frequency. Further, on the downlink and uplink channels, the coverage of each access node 554 could define an air interface configured in a specific manner to define physical resources for carrying information wirelessly between the access node 554 and UEs 552.

Without limitation, for instance, the air interface could be divided over time into frames, subframes, and symbol time segments, and over frequency into subcarriers that could be modulated to carry data. The example air interface could thus define an array of time-frequency resource elements each being at a respective symbol time segment and subcarrier, and the subcarrier of each resource element could be modulated to carry data. Further, in each subframe or other transmission time interval (TTI), the resource elements on the downlink and uplink could be grouped to define physical resource blocks (PRBs) that the access node could allocate as needed to carry data between the access node and served UEs 552.

In addition, certain resource elements on the example air interface could be reserved for special purposes. For instance, on the downlink, certain resource elements could be reserved to carry synchronization signals that UEs 552 could detect as an indication of the presence of coverage and to establish frame timing, other resource elements could be reserved to carry a reference signal that UEs 552 could measure in order to determine coverage strength, and still other resource elements could be reserved to carry other control signaling such as PRB-scheduling directives and acknowledgement messaging from the access node 554 to served UEs 552. And on the uplink, certain resource elements could be reserved to carry random access signaling from UEs 552 to the access node 554, and other resource elements could be reserved to carry other control signaling such as PRB-scheduling requests and acknowledgement signaling from UEs 552 to the access node 554.

The access node 554, in some instances, may be split functionally into a radio unit (RU), a distributed unit (DU), and a central unit (CU) where each of the RU, DU, and CU have distinctive roles to play in the access network 556. The RU provides radio functions. The DU provides L1 and L2 real-time scheduling functions; and the CU provides higher L2 and L3 non-real time scheduling. This split supports flexibility in deploying the DU and CU. The CU may be hosted in a regional cloud data center. The DU may be co-located with the RU, or the DU may be hosted in an edge cloud data center.

Turning now to FIG. 9B, further details of the core network 558 are described. In an embodiment, the core network 558 is a 5G core network. 5G core network technology is based on a service based architecture paradigm. Rather than constructing the 5G core network as a series of special purpose communication nodes (e.g., an HSS node, a MME node, etc.) running on dedicated server computers, the 5G core network is provided as a set of services or network functions. These services or network functions can be executed on virtual servers in a cloud computing environment which supports dynamic scaling and avoidance of long-term capital expenditures (fees for use may substitute for capital expenditures). These network functions can include, for example, a user plane function (UPF) 579, an authentication server function (AUSF) 575, an access and mobility management function (AMF) 576, a session management function (SMF) 577, a network exposure function (NEF) 570, a network repository function (NRF) 571, a policy control function (PCF) 572, a unified data management (UDM) 573, a network slice selection function (NSSF) 574, and other network functions. The network functions may be referred to as virtual network functions (VNFs) in some contexts.

Network functions may be formed by a combination of small pieces of software called microservices. Some microservices can be re-used in composing different network functions, thereby leveraging the utility of such microservices. Network functions may offer services to other network functions by extending application programming interfaces (APIs) to those other network functions that call their services via the APIs. The 5G core network 558 may be segregated into a user plane 580 and a control plane 582, thereby promoting independent scalability, evolution, and flexible deployment.

The UPF 579 delivers packet processing and links the UE 552, via the access network 556, to a data network 590 (e.g., the network 560 illustrated in FIG. 5A). The AMF 576 handles registration and connection management of non-access stratum (NAS) signaling with the UE 552. Said in other words, the AMF 576 manages UE registration and mobility issues. The AMF 576 manages reachability of the UEs 552 as well as various security issues. The SMF 577 handles session management issues. Specifically, the SMF 577 creates, updates, and removes (destroys) protocol data unit (PDU) sessions and manages the session context within the UPF 579. The SMF 577 decouples other control plane functions from user plane functions by performing dynamic host configuration protocol (DHCP) functions and IP address management functions. The AUSF 575 facilitates security processes.

The NEF 570 securely exposes the services and capabilities provided by network functions. The NRF 571 supports service registration by network functions and discovery of network functions by other network functions. The PCF 572 supports policy control decisions and flow based charging control. The UDM 573 manages network user data and can be paired with a user data repository (UDR) that stores user data such as customer profile information, customer authentication number, and encryption keys for the information. An application function 592, which may be located outside of the core network 558, exposes the application layer for interacting with the core network 558. In an embodiment, the application function 592 may be executed on an application server 559 located geographically proximate to the UE 552 in an “edge computing” deployment mode. The core network 558 can provide a network slice to a subscriber, for example an enterprise customer, that is composed of a plurality of 5G network functions that are configured to provide customized communication service for that subscriber, for example to provide communication service in accordance with communication policies defined by the customer. The NSSF 574 can help the AMF 576 to select the network slice instance (NSI) for use with the UE 552.

FIG. 10 illustrates a computer system 380 suitable for implementing one or more embodiments disclosed herein. The computer system 380 includes a processor 382 (which may be referred to as a central processor unit or CPU) that is in communication with memory devices including secondary storage 384, read only memory (ROM) 386, RAM 388, input/output (I/O) devices 390, and network connectivity devices 392. The processor 382 may be implemented as one or more CPU chips.

It is understood that by programming and/or loading executable instructions onto the computer system 380, at least one of the CPU 382, the RAM 388, and the ROM 386 are changed, transforming the computer system 380 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an ASIC that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 380 is turned on or booted, the CPU 382 may execute a computer program or application. For example, the CPU 382 may execute software or firmware stored in the ROM 386 or stored in the RAM 388. In some cases, on boot and/or when the application is initiated, the CPU 382 may copy the application or portions of the application from the secondary storage 384 to the RAM 388 or to memory space within the CPU 382 itself, and the CPU 382 may then execute instructions that the application is comprised of. In some cases, the CPU 382 may copy the application or portions of the application from memory accessed via the network connectivity devices 392 or via the I/O devices 390 to the RAM 388 or to memory space within the CPU 382, and the CPU 382 may then execute instructions that the application is comprised of. During execution, an application may load instructions into the CPU 382, for example load some of the instructions of the application into a cache of the CPU 382. In some contexts, an application that is executed may be said to configure the CPU 382 to do something, e.g., to configure the CPU 382 to perform the function or functions promoted by the subject application. When the CPU 382 is configured in this way by the application, the CPU 382 becomes a specific purpose computer or a specific purpose machine.

The secondary storage 384 is typically comprised of one or more disk drives or tape drives and is used for non-volatile storage of data and as an over-flow data storage device if RAM 388 is not large enough to hold all working data. Secondary storage 384 may be used to store programs which are loaded into RAM 388 when such programs are selected for execution. The ROM 386 is used to store instructions and perhaps data which are read during program execution. ROM 386 is a non-volatile memory device which typically has a small memory capacity relative to the larger memory capacity of secondary storage 384. The RAM 388 is used to store volatile data and perhaps to store instructions. Access to both ROM 386 and RAM 388 is typically faster than to secondary storage 384. The secondary storage 384, the RAM 388, and/or the ROM 386 may be referred to in some contexts as computer readable storage media and/or non-transitory computer readable media.

I/O devices 390 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 392 may take the form of modems, modem banks, Ethernet cards, USB interface cards, serial interfaces, token ring cards, fiber distributed data interface (FDDI) cards, wireless local area network (WLAN) cards, radio transceiver cards, and/or other well-known network devices. The network connectivity devices 392 may provide wired communication links and/or wireless communication links (e.g., a first network connectivity device 392 may provide a wired communication link and a second network connectivity device 392 may provide a wireless communication link). Wired communication links may be provided in accordance with Ethernet (IEEE 802.3), IP, time division multiplex (TDM), data over cable service interface specification (DOCSIS), wavelength division multiplexing (WDM), and/or the like. In an embodiment, the radio transceiver cards may provide wireless communication links using protocols such as CDMA, global system for mobile communications (GSM), LTE, WiFi (IEEE 802.11), Bluetooth, Zigbee, narrowband Internet of things (NB IoT), near field communications (NFC), and radio frequency identity (RFID). The radio transceiver cards may promote radio communications using 5G, 5G New Radio, or 5G LTE radio communication protocols. These network connectivity devices 392 may enable the processor 382 to communicate with the Internet or one or more intranets. With such a network connection, it is contemplated that the processor 382 might receive information from the network, or might output information to the network in the course of performing the above-described method steps. Such information, which is often represented as a sequence of instructions to be executed using processor 382, may be received from and outputted to the network, for example, in the form of a computer data signal embodied in a carrier wave.

Such information, which may include data or instructions to be executed using processor 382 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 382 executes instructions, codes, computer programs, scripts which it accesses from hard disk, floppy disk, optical disk (these various disk-based systems may all be considered secondary storage 384), flash drive, ROM 386, RAM 388, or the network connectivity devices 392. While only one processor 382 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 384, for example, hard drives, floppy disks, optical disks, and/or other device, the ROM 386, and/or the RAM 388 may be referred to in some contexts as non-transitory instructions and/or non-transitory information.

In an embodiment, the computer system 380 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 380 to provide the functionality of a number of servers that is not directly bound to the number of computers in the computer system 380. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 380, at least portions of the contents of the computer program product to the secondary storage 384, to the ROM 386, to the RAM 388, and/or to other non-volatile memory and volatile memory of the computer system 380. The processor 382 may process the executable instructions and/or data structures in part by directly accessing the computer program product, for example by reading from a CD-ROM disk inserted into a disk drive peripheral of the computer system 380. Alternatively, the processor 382 may process the executable instructions and/or data structures by remotely accessing the computer program product, for example by downloading the executable instructions and/or data structures from a remote server through the network connectivity devices 392. The computer program product may comprise instructions that promote the loading and/or copying of data, data structures, files, and/or executable instructions to the secondary storage 384, to the ROM 386, to the RAM 388, and/or to other non-volatile memory and volatile memory of the computer system 380.

In some contexts, the secondary storage 384, the ROM 386, and the RAM 388 may be referred to as a non-transitory computer readable medium or a computer readable storage media. A dynamic RAM embodiment of the RAM 388, likewise, may be referred to as a non-transitory computer readable medium in that while the dynamic RAM receives electrical power and is operated in accordance with its design, for example during a period of time during which the computer system 380 is turned on and operational, the dynamic RAM stores information that is written to it. Similarly, the processor 382 may comprise an internal RAM, an internal ROM, a cache memory, and/or other internal non-transitory storage blocks, sections, or components that may be referred to in some contexts as non-transitory computer readable media or computer readable storage media.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A computer-implemented method of collecting, monitoring, and analyzing power consumption information associated with individual electrical appliances, the method comprising:
establishing, by an application stored in a non-transitory memory of a communication hub device and executable by a processor of the communication hub device, wireless communication links with respective ones of a plurality of smart plugs, each electrically coupled between an electrical power outlet and one or more of a plurality of electrical appliances and comprises one or more sensors for sensing at least one of a current or a voltage;
receiving, by the application, a mapping between each of the plurality of electrical appliances and a respective one of the plurality of smart plugs, the mapping being based on a respective electrical coupling;
receiving, by the application, from individual ones of the plurality of smart plugs, sensing data comprising at least one of current or voltage consumption information;
associating, by the application, based on the mapping, at least one electrical appliance of the plurality of electrical appliances with respective sensing data;
calculating, by the application, power consumption information for the at least one electrical appliance based on the respective sensing data;
detecting, by the application, an anomaly based on at least one of the sensing data or the power consumption information associated with the at least one electrical appliance fails to satisfy one or more criteria; and
initiating, by the application, an action to resolve the detected anomaly.

2. The method of claim 1, wherein:
the sensing data associated with the at least one electrical appliance is received from a first smart plug of the plurality of smart plugs, and
the initiating the action to resolve the detected anomaly comprises:
transmitting, by the application, to the first smart plug, an instruction to modify a power state of the at least one electrical appliance.

3. The method of claim 1, wherein the detecting the anomaly comprises:
determining, by the application, based at least in part on the sensing data associated with the at least one electrical appliance, that a current load fails to satisfy a threshold.

4. The method of claim 1, wherein:
the detecting the anomaly comprises:
determining, by the application, based at least in part on the sensing data associated with the at least one electrical appliance, that a ground-fault circuit interrupter (GFCI) circuit associated with an electric power outlet electrically coupled to the at least one electrical appliance is tripped, and the initiating the action to resolve the detected anomaly comprises:
transmitting, by the application, a notification to reset the GFCI circuit.

5. The method of claim 1, wherein:
the detecting the anomaly comprises:
determining, by the application, that a difference between the calculated power consumption information for the at least one electrical appliance and a reference power consumption exceeds a threshold, and the initiating the action to resolve the detected anomaly comprises:
transmitting, by the application, a request to adjust a power configuration associated with the at least one electrical appliance.

6. The method of claim 1, further comprising:
receiving, by the application, via a web portal associated with the communication hub device or a web application on a user device, a power consumption request for the at least one electrical appliance; and
outputting, by the application, to the web portal or the web application, based on the power consumption request, the calculated power consumption information for the at least one electrical appliance.

7. A computer-implemented method of collecting, monitoring, and analyzing power consumption information associated with individual electrical appliances, the method comprising:
establishing, by an application stored in a non-transitory memory of a communication hub device and executable by a processor of the communication hub device, wireless communication links with respective ones of a plurality of electrical metering-capable devices, each electrically coupled to one or more of a plurality of electrical appliances and comprising one or more sensors for sensing at least one of a current or a voltage, wherein the plurality electrical metering-capable devices comprise at least one of a smart circuit breaker or a smart plug;
displaying, by the application, via a first user interface (UI), an indication of the plurality of electrical metering-capable devices based on the established wireless communication links;
receiving, by the application, via the UI, a mapping between the plurality of electrical appliances and the plurality of electrical metering-capable devices;
receiving, by the application, from the one or more sensors at individual ones of the plurality of electrical metering-capable devices, sensing data comprising at least one of current or voltage consumption information;
associating, by the application, based on the mapping, individual ones of the plurality of electrical appliances with respective sensing data;
calculating, by the application, a power consumption for the individual ones of the plurality of electrical appliances based on the respective sensing data; and
outputting, by the application, to a second UI, an indication of the calculated power consumption for the individual ones of the plurality of electrical appliances.

8. The method of claim 7, wherein the displaying further comprises:
displaying, by the application, via the first UI, one or more candidate electrical appliance identifiers for at least one electric metering-capable device of the plurality of electrical metering-capable devices.

9. The method of claim 8, further comprising:
determining, by the application, the one or more candidate electrical appliance identifiers for the at least one electric metering-capable device on a power consumption pattern associated with the at least one electric metering-capable device.

10. The method of claim 8, further comprising:
applying, by the application, a machine learning (ML) model to power consumption data associated with the at least one electric metering-capable device; and
receiving, by the application, from the ML model, the one or more candidate electrical appliance identifiers for the at least one electric metering-capable device.

11. The method of claim 8, further comprising:
receiving, by the application, a selection of a first candidate electrical appliance identifier from the one or more candidate electrical appliance identifiers for a first electrical appliance of the plurality of electrical appliances coupled to the at least one electric metering-capable device,
wherein the outputting the indication of the calculated power consumption for the individual ones of the plurality of electrical appliances comprises:
displaying, via the second UI, an indication of the selected first electrical appliance identifier in association with the power consumption calculated for the first electrical appliance.

12. The method of claim 7, wherein the communication hub device is part of a fixed wireless access point, and wherein the wireless communication links established with the plurality of electrical metering-capable devices are Institute of electrical and electronics engineers (IEEE) 802.11 connections.

13. A method comprising:
establishing, by an application stored in a non-transitory memory of a communication hub device and executable by a processor of the communication hub device, wireless communication links with respective ones of a plurality of smart circuit breakers associated with a home, wherein each of the plurality of smart circuit breakers electrically couples an electric main of the home to one or more of a plurality of electrical appliances associated with the home and comprises one or more sensors for sensing at least one of a current or a voltage;
receiving, by the application, a mapping between each of the plurality of electrical appliances and a corresponding one of the plurality of smart circuit breakers, the mapping being based on a respective electric coupling;
receiving, by the application, from individual ones of the plurality of smart circuit breakers, sensing data comprising at least one of current or voltage consumption information;
associating, by the application, based on the mapping, at least one electrical appliance of the plurality of electrical appliances with respective sensing data;
calculating, by the application, power consumption information for the at least one electrical appliance based on the respective sensing data;
detecting, by the application, an anomaly based on a comparison of the power consumption information of the at least one electrical appliance to reference power consumption data; and
transmitting, by the application to a user device, a notification of the detected anomaly.

14. The method of claim 13, further comprising:
displaying, by the application, via a user interface (UI), an indication of the plurality of smart circuit breakers based on the established wireless communication links,
wherein the mapping is received via the UI in response to the displaying and comprises an electrical appliance identifier assigned to the at least one electrical appliance and mapped to a corresponding one of the plurality of smart circuit breakers electrically coupled to the at least one electrical appliance.

15. The method of claim 14, wherein the UI is part of a web portal associated with the communication hub device or a web application on the user device.

16. The method of claim 14, further comprising:
displaying, by the application, via the UI, an indication of the calculated power consumption information for the at least one electrical appliance in association with the electrical appliance identifier assigned to the at least one electrical appliance.

17. The method of claim 13, wherein the reference power consumption data used for the comparison to detect the anomaly comprises past power consumption data associated with the at least one electrical appliance.

18. The method of claim 13, wherein the reference power consumption data used for the comparison to detect the anomaly comprises power consumption data associated with electrical appliances of the same product type as the at least one electrical appliance.

19. The method of claim 13, further comprising:
predicting, by the application, an electrical billing cost based on the sensing data received from the individual ones of the plurality of smart circuit breakers;
detecting, by the application, a second anomaly based on a comparison of the predicted electrical billing cost and at least one of past electrical billing information associated with the home or electrical billing information associated with neighboring homes; and
transmitting, by the application to the user device, a notification of the detected second anomaly.

20. The method of claim 13, wherein:
the communication hub device is a home network router, and
the calculating the power consumption information for the at least one electrical appliance is part of a home Internet service.
